(19) United States
(12) Patent Application Publication
(10) Pub. No.: US 2018/0235155 A1
(43) Pub. Date: Aug. 23, 2018

(54) PLANT CULTIVATION METHOD AND PLANT CULTIVATION DEVICE

(71) Applicants: SHARP KABUSHIKI KAISHA, Sakai City, Osaka (JP); NATIONAL UNIVERSITY CORP. SHIZUOKA UNIVERSITY, Shizuoka City (JP)

(72) Inventors: HIROKAZU FUNAMORI, Sakai City (JP); SATOHIKO YAMAMOTO, Sakai City (JP); KAZUSHI IYATANI, Sakai City (JP); KAZUO NISHIKAWA, Sakai City (JP); TAKASHI IKKA, Shizuoka City (JP); AKIO MORITA, Shizuoka City (JP); YASUNO TANAKA, Shizuoka City (JP); YOSHIKI ONO, Shizuoka City (JP)

(21) Appl. No.: 15/753,738

(22) PCT Filed: Aug. 31, 2016
(86) PCT No.: PCT/JP2016/075440

§ 371 Date: Feb. 20, 2018

(30) Foreign Application Priority Data
Feb. 29, 2016 (JP) 2016-037499

(51) Int. Cl. A01G 7/04; A01G 9/20; A01G 9/24; A01G 9/26

(52) U.S. Cl. CPC A01G 7/045; A01G 9/20; A01G 31/02; A01G 9/26; A01G 9/246

(57) ABSTRACT

Plant growth is promoted by a simple method. A plant (10) is irradiated with a positive ion and a negative ion.

### TECHNICAL FIELD

The present invention relates to a plant cultivation method for promoting growth of a plant, and particularly to a method for promoting growth of a plant that is cultivated in a plant cultivation apparatus. The present invention also relates to a plant cultivation apparatus for promoting growth of a plant that is cultivated in the cultivation apparatus.

### BACKGROUND ART

As systematic production of agricultural products is being desired, expectations for (i) facility cultivation and (ii) a plant factory, each of which is less susceptible to, for example, weather, are growing. Further, it is socially demanded that plant cultivation be efficiently carried out in such facility cultivation and such a plant factory. Examples of a technique that is being developed in response to such a demand include the following techniques disclosed in Patent Literatures 1 to 3.

Patent Literature 1 discloses that a positive ion and a negative ion are used to prevent mold and bacteria from propagating in a plant cultivation environment.

Patent Literature 2 discloses (i) that plant growth is promoted by negative ion irradiation and (ii) that a harvest irradiated with a negative ion is kept fresh longer than a harvest irradiated with no negative ion.

Patent Literature 3 discloses that a positive ion and a negative ion are used to promote pigment accumulation in a plant.

### CITATION LIST

### Patent Literatures

[Patent Literature 1]

Japanese Patent Application Publication, Tokukai, No. 2013-223457 (Publication Date: Oct. 31, 2013)

[Patent Literature 2]

Japanese Patent Application Publication, Tokukaihei, No. 11-239418 (Publication Date: Sep. 7, 1999)

[Patent Literature 3]

Japanese Patent Application Publication, Tokukai, No. 2012-135288 (Publication Date: Jul. 19, 2012)

### SUMMARY OF INVENTION

### Technical Problem

The inventors of the present invention found, by experiment, a phenomenon such that plant growth is promoted by generating a positive ion and a negative ion in a plant cultivation environment. It is socially demanded that plant cultivation be efficiently carried out, and the above phenomenon is desired to be efficiently used.

An object of the present invention is to provide a plant cultivation method and a plant cultivation apparatus each allowing efficient plant cultivation.

### Solution to Problem

In order to attain the object, a plant cultivation method in accordance with an aspect of the present invention is a plant cultivation method for promoting growth of a plant, including: a positive and negative ion irradiation step of irradiating the plant with a positive ion and a negative ion.

In order to attain the object, a plant cultivation apparatus in accordance with an aspect of the present invention is a plant cultivation apparatus for promoting growth of a plant, including: an ion generating device that generates a positive ion and a negative ion in a space in which the plant is cultivated.

### Advantageous Effects of Invention

An aspect of the present invention yields an effect of promoting plant growth by a simple method.

### BRIEF DESCRIPTION OF DRAWINGS

(a) and (b) of FIG. 1 are a front cross-sectional view and a top cross-sectional view, respectively, each schematically illustrating an arrangement of a plant cultivation apparatus in accordance with Embodiment 1 of the present invention.

FIG. 2 is a functional block diagram schematically showing a function of the plant cultivation apparatus illustrated in FIG. 1.

FIG. 3 schematically illustrates airflows in the plant cultivation apparatus illustrated in FIG. 1.

FIG. 4 is a top cross-sectional view schematically illustrating an arrangement of a plant cultivation apparatus in accordance with Embodiment 2 of the present invention.

(a) of FIG. 5 is a copy of a photograph showing a plant cultivated in a plant cultivation apparatus of an Example of the present invention, and (b) of FIG. 5 is a copy of a photograph showing a plant cultivated in a plant cultivation apparatus of a Comparative Example.

(a) of FIG. 6 is a copy of a photograph showing a root of a plant cultivated in a plant cultivation apparatus of an Example of the present invention, and (b) of FIG. 6 is a copy of a photograph showing a root of a plant cultivated in a plant cultivation apparatus of a Comparative Example.

FIG. 7 has bar graphs showing averages and deviations of (a) a maximum leaf length, (b) the number of leaves, (c) a fresh weight of an above-ground part, and (d) a dry weight of the above-ground part of (i) each individual plant (A) cultivated in a plant cultivation apparatus of an Example of the present invention and (ii) each individual plant (B) cultivated in a plant cultivation apparatus of a Comparative Example.

FIG. 8 has bar graphs showing averages and deviations of (a) a root length, (b) a fresh weight of a root, and (c) a dry weight of the root of (i) the each individual plant (A) cultivated in the plant cultivation apparatus of an Example of the present invention and (ii) the each individual plant (B) cultivated in the plant cultivation apparatus of a Comparative Example.

FIG. 9 has bar graphs showing averages and deviations of (a) a nitrate ion (NO₃⁻) content and (b) an oxalic acid content in a plant (A) cultivated in a plant cultivation apparatus of an Example of the present invention and a plant (B) cultivated in a plant cultivation apparatus of a Comparative Example.

FIG. 10 shows a result of RNA sequencing carried out by use of a plant cultivated in a plant cultivation apparatus of an Example of the present invention and a plant cultivated in a plant cultivation apparatus of a Comparative Example.

FIG. 11 shows a result, obtained as a result of the RNA sequencing, of an MA plot showing a difference in gene expression level.

FIG. 12A is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12B is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12C is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12D is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12E is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12F is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12G is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12H is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12I is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 12J is a list of (i) patterns of expression of contigs, whose expression level was significantly increased or decreased, out of patterns of expression of contigs obtained by RNA sequencing of a plant cultivated in a plant cultivation apparatus of an Example of the present invention and a plant cultivated in a plant cultivation apparatus of a Comparative Example and (ii) results of annotation added by a BLAST program to the contigs thus obtained.

FIG. 13A shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13B shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13C shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13D shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13E shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13F shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13G shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13H shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13I shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 13J shows results of gene ontology enrichment analysis carried out based on a result of annotation added by a BLAST program to contigs identified by RNA sequencing carried out by use of a plant cultivated in a plant cultivation apparatus of an Example of the present invention and a plant cultivated in a plant cultivation apparatus of a Comparative Example.

FIG. 14 is a view obtained by partially drawing, on a TCA cycle pathway and an urea cycle metabolic pathway. results of metabolome analysis carried out by use of a plant cultivated in a plant cultivation apparatus of an Example of the present invention and a plant cultivated in a plant cultivation apparatus of a Comparative Example.

FIG. 15 shows results of analysis of amounts of accumulation of part of amino acids out of results of metabolome analysis carried out by use of a plant (A) cultivated in a plant cultivation apparatus of an Example of the present invention and a plant (B) cultivated in a plant cultivation apparatus of a Comparative Example.

FIG. 16 shows results of analysis of amounts of accumulation of metabolic substances, which have not been drawn on a metabolic pathway map, out of results of metabolome analysis carried out by use of a plant (A) cultivated in a plant cultivation apparatus of an Example of the present invention and a plant (B) cultivated in a plant cultivation apparatus of a Comparative Example.

FIG. 17 is a list of contigs, which have been identified by the RNA sequencing, out of contigs corresponding to genes involved in biosynthesis of metabolic products shown in FIG. 14.

### DESCRIPTION OF EMBODIMENTS

### Embodiment 1

The following description specifically discusses Embodiment 1 of the present invention with reference to FIGS. 1 through 3.

FIG. 1 schematically illustrates an arrangement of a plant cultivation apparatus 1 in accordance with Embodiment 1. (a) and (b) of FIG. 1 are a front cross-sectional view and a top cross-sectional view, respectively, of the plant cultivation apparatus 1. The plant cultivation apparatus 1 hydroponically cultivates plants 10 and promotes growth of the plants 10.

The plant cultivation apparatus 1 includes a case 30, a control device 20, an illumination device 21, an air sending device 22, a door 31, an air hole 23, and ion generating devices 40 each of which generates a positive ion and a negative ion. In the plant cultivation apparatus 1, a hydroponic liquid vessel 14 is provided so that the plants 10 are cultivated. In the hydroponic liquid vessel 14, a float 12 having holes in which sponges 11 which support the respective plants 10 are provided is floated on a hydroponic liquid 13.

In order that the drawings are easily understood, the drawings show an xyz orthogonal coordinate system in which a direction in which a long side of the case 30 extends is an x direction, a direction in which a short side of the case 30 extends is a y direction, and a direction in which a height of the case 30 extends is a z direction.

In accordance with (i) the plants 10 which are to be cultivated and (ii) an environment in which to provide the plant cultivation apparatus 1, the plant cultivation apparatus 1 can include a piece of equipment such as an air conditioning device capable of positively adjusting a temperature inside the case 30, an air pump for increasing an amount of dissolved oxygen of the hydroponic liquid 13, or a circulation pump for circulating the hydroponic liquid 13. Further, the plant cultivation apparatus 1 can cultivate the plants 10 not only by hydroponic cultivation but also by providing solid media (such as compost) in the plant cultivation apparatus 1.

(Plant 10)

First, a plant 10 to be cultivated is described below.

The plant 10 can be any plant such as a leaf vegetable, a fruit-bearing vegetable, a root vegetable, or a flowering plant.

Examples of the plant 10 which is the leaf vegetable can include various kinds of lettuces such as Great Lakes, Gentilina Green, and Salad Bowl Red, a salad green, sangchu, a garland chrysanthemum, a potherb mustard, Tukena (Brassica rapa L. cv. Shin-shin-sai), a wasabi green, Brassica campestris, bok choy, a beefsteak plant leaf, Brassica rapa L. Oleifera Group, ruccola, Tah Tsai, Brassica campestris var. komatsuna, Beet All Red, and herbs such as Italian parsley, sweet basil. cresson, phak chi, spearmint, and peppermint. Note that the plant 10 can be cultivated so as to be harvested in a form of a baby leaf instead of being harvested after being sufficiently grown.

Examples of the plant 10 which is the fruit-bearing vegetable can include a cherry tomato. Examples of the plant 10 which is the root vegetable can include a small turnip and a radish.

Since a sponge 11, the float 12, the hydroponic liquid 13, and the hydroponic liquid vessel 14, each of which is a piece of equipment for cultivating the plant 10, are well-known techniques for carrying out hydroponic cultivation, a description thereof is omitted here. Further, since cultivation methods other than hydroponic cultivation are also well-known techniques, a description thereof is omitted here.

(Plant Cultivation Apparatus 1)

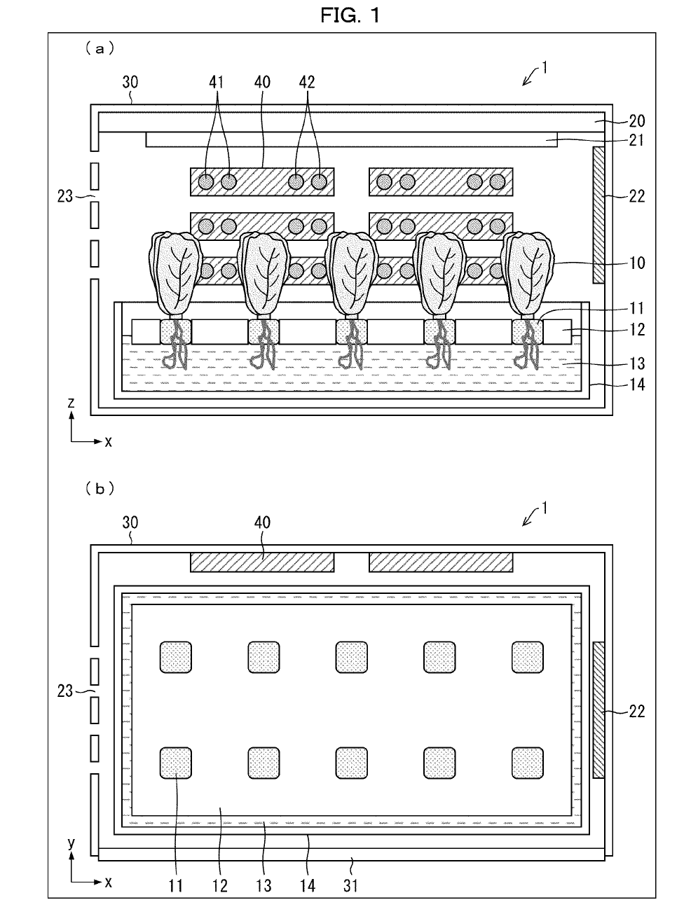

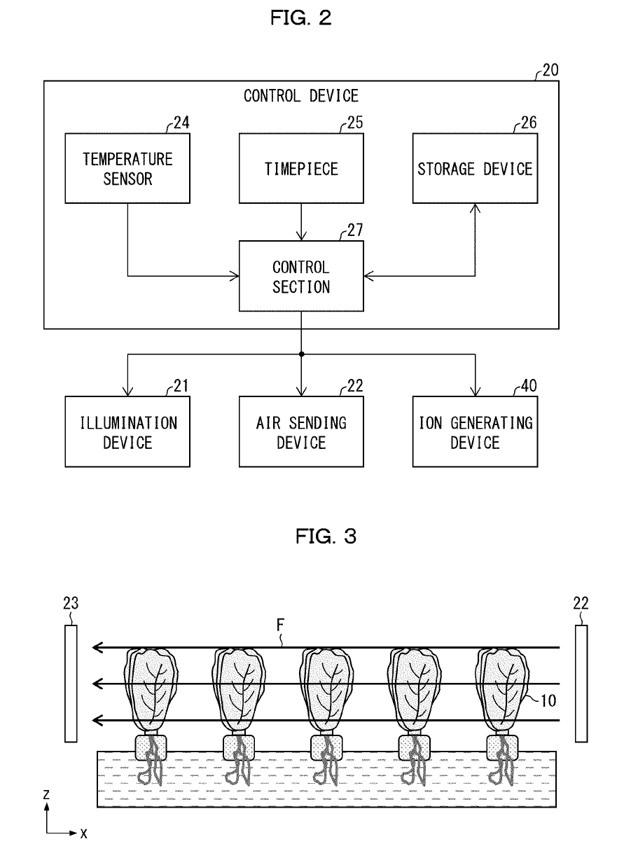

Next, the plant cultivation apparatus 1 is described below with reference to FIGS. 1 and 2.

In order that positive and negative ions which are generated by the ion generating devices 40 can be retained in the case 30, the case 30 except parts thereof in which parts the air sending device 22 and the air hole 23, respectively are provided is made substantially airtight while the door 31 is closed. In order that an inside of the case 30 (in particular, the plant 10 and an amount of water of the hydroponic liquid 13) can be observed and viewed from an outside of the case 30, the case 30 is partially made of a translucent member that is colorless and transparent. The case 30, which only needs to be a structure that can (i) support the control device 20, the illumination device 21, the air sending device 22, and the door 31, and (ii) protect the plant 10 which is being cultivated, does not necessarily need to be made of any particular material and have any particular shape and size.

As illustrated in FIG. 2, the control device 20 includes therein a temperature sensor 24, a timepiece 25, a storage device 26, and a control section 27. The storage device 26 stores therein (i) a pattern, in accordance with a time, of (a) an illumination time of the illumination device 21 and (b) an illumination light amount of the illumination device 21, (ii) a given range within which to maintain the temperature inside the case 30, and (iii) a drive pattern of an ion generating device 40 in accordance with a time. The control section 27 controls, with reference to time information from the timepiece 25, the illumination time of the illumination device 21 and the illumination light amount of the illumination device 21 in accordance with a time. Further, in order that the temperature inside the case 30 is maintained so as to fall within the given range, the control section 27 also controls, with reference to temperature information from the temperature sensor 24, an amount of air that is sent by the air sending device 22.

The control section 27 of the control device 20 may be realized by a logic circuit (hardware) provided in an integrated circuit (IC chip) or the like or may be realized by software as executed by a Central Processing Unit (CPU).

In the latter case, the control section 27 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

The temperature sensor 24 is a sensor that senses a temperature of air inside the case 30. In addition, the control device 20 can include a sensor that senses (i) a temperature or the amount of water of the hydroponic liquid or (ii) a humidity of the air or a carbon dioxide concentration inside the case.

The illumination device 21 is provided on a top surface of the case 30 so as to illuminate the plant 10 from above. Further, the illumination device 21, which is a light emitting device (LED) illumination device that generates heat in a smaller amount, is not particularly limited provided that the illumination device 21 can radiate heat so that the inside of the case 30 is not overheated. Instead of providing an illumination device, it is also possible to use external light (sunlight or interior illumination).

The air sending device 22 is a suction fan that sucks in air from the outside to the inside of the case 30. The air hole 23 is an exhaust hole through which to exhaust air from the inside to the outside of the case 30. The air sending device 22 and the air hole 23 are provided on respective wall surfaces so as to face each other in the x direction. Thus, as illustrated in FIG. 3, an airflow F that is produced between the air sending device 22 and the air hole 23 moves in the x direction, and the airflow F takes place so that the plant 10 which grows in a z-axis positive direction is laterally subjected to the airflow F (ideally, the plant 10 which grows in the z-axis positive direction is subjected to the airflow F so as to be substantially orthogonal to the airflow F which moves in the x direction) (an air sending step).

In a case where the temperature sensor 24 detects a higher temperature, a fan of the air sending device 22 rotates more times. Such an arrangement prevents an increase in temperature inside the case 30.

Note that the air sending device 22 can also be an exhaust fan that exhausts air. In a case where the air sending device 22 is such an exhaust fan, the air hole 23 is a suction hole through which to suck in air. Alternatively, instead of combining the air sending device 22 and the air hole 23, it is possible to provide two air sending devices 22, one of which is a suction fan, and the other of which is an exhaust fan. Further, in a case where an airflow outside the case 30 is strong, it is also possible to provide two air holes 23.

The door 31 is not particularly limited in placement and arrangement provided that the door 31 allows the hydroponic liquid vessel 14 to be taken in and out of the case 30 while the plant 10 is being cultivated.

The ion generating devices 40 are each provided on a wall surface of the case 30 so as to be parallel to the airflow F and so as to face in a y-axis negative direction as illustrated in (b) of FIG. 1. An ion generating device 40 is specifically described later. Since the inside of the case 30 except the parts in which the air sending device 22 and the air hole 23, respectively are provided is an enclosed space, a positive ion and a negative ion each generated by the ion generating device 40 are diffused throughout the inside of the case 30 by the airflow.

The inside of the case 30 has a positive ion concentration of not less than 1,000,000 ions/cm³ and a negative ion concentration of not less than 1,000,000 ions/cm³. In order that these positive and negative ion concentrations are maintained, the ion generating device 40 can also be controlled by the control section 27. Further, the ion generating device 40 efficiently diffuses more positive ions and more negative ions in a case where the airflow F is produced by the air sending device 22 at a higher speed. Thus, in a case where the fan of the air sending device 22 rotates more times, the inside of the case 30 has a higher positive ion concentration and a higher negative ion concentration.

(Ion Generating Device 40)

The following description discusses an arrangement of the ion generating device 40.

The ion generating device 40 has a main part that is provided with a high voltage generating circuit for generating a high voltage pulse, a positive ion generating section 41, and a negative ion generating section 42. The positive ion generating section 41 includes a dielectric electrode (not illustrated) and a discharge electrode (not illustrated). To the positive ion generating section 41, a positive voltage pulse generated by the high voltage generating circuit is applied. This causes the positive ion generating section 41 to generate a positive ion. Similarly, the negative ion generating section 42 also includes a dielectric electrode and a discharge electrode, and the negative ion generating section 42 to which a negative voltage pulse has been applied generates a negative ion.

The above-described arrangement of the ion generating device 40 is merely an example, and the ion generating device 40 is not particularly limited in arrangement provided that the ion generating device 40 is a device that is capable of generating a positive ion and a negative ion each having a desired concentration.

The following description discusses an effect that is yielded by the ion generating device 40.

A positive ion that is generated by the ion generating device 40 is an ion that consists mainly of H⁺H₂O)ₘ (m is any natural number), and a negative ion that is generated by the ion generating device 40 is an ion that consists mainly of O₂⁻(H₂O)ₙ (n is any natural number).

Thus, in a case where a positive ion and a negative ion are simultaneously present in air, a hydroxyl radical (.OH), which is an active oxygen species, is considered to be efficiently produced by a chemical reaction between the positive ion and the negative ion (see the following (Formula 1) and (Formula 2) where n′ and m′ are each any natural number).

H⁺(H₂O)ₘ+O₂⁻(H₂O)ₙ→.OH+1/2O₂+(m+n)H₂O (Formula 1)

H⁺(H₂O)ₘ+H⁺(H₂O)ₘ′+O₂⁻(H₂O)ₙ+O₂⁻(H₂O)_{n′}→2.OH+O₂+(m+m′+n+n′)H₂O (Formula 2)

It is considered that a hydroxyl radical is less conspicuously produced in a case where only a positive ion or a negative ion is released into air, whereas a hydroxyl radical is conspicuously produced in a case where simultaneous release of a positive ion and a negative ion causes a reaction between (a) the positive ion which is stabilized by a cluster that is formed by the positive ion and water molecule(s) and (b) the negative ion which is stabilized by a cluster that is formed by the negative ion and water molecule(s).

It is considered that a produced positive ion and a produced negative ion, and an action of a hydroxyl radical promote growth of the plant 10. For example, it is considered that a hydroxyl radical applies oxidative stress to the plant 10 and growth of the plant 10 is promoted by the oxidative stress.

A space in which the plant 10 is cultivated preferably has a positive ion concentration of not less than 1,000,000 ions/cm³ and a negative ion concentration of not less than 1,000,000 ions/cm³.

It is preferable that a plurality of plant individuals be uniformly irradiated with positive ions and negative ions. Note, however, that positive ions and negative ions do not necessarily need to be uniformly dispersed throughout a space in which the plants 10 are cultivated. The above positive ion concentration and the above negative ion concentration are preferable concentrations obtained in a vicinity of each of the plants 10.

Of Plasmacluster products (manufactured by SHARP KABUSHIKI KAISHA) which are currently commercially available, a Plasmacluster product that releases high concentration positive ions and high concentration negative ions releases, into a space in which a human lives, positive ions whose concentration is approximately 100,000 ions/cm³ and negative ions whose concentration is approximately 100,000 ions/cm³. Thus, positive and negative ions with which the plants 10 are irradiated are much higher in concentration than positive and negative ions each of which is released, into a space in which a human lives, so that bacteria or viruses are removed and inactivated.

Since neither of a positive ion and a negative ion inhibits growth of a plant 10, it is possible to irradiate the plant 10 with the positive ion and the negative ion throughout a period in which the plant 10 is cultivated (positive and negative ion irradiation step). Specifically, it is possible to continuously carry out positive and negative ion irradiation with respect to the plant 10 without setting any particular irradiation time period or irradiation period. This makes it unnecessary to set, in detail, a positive ion irradiation time period and a negative ion irradiation time period, and a positive ion irradiation period and a negative ion irradiation period.

Further, a positive ion and a negative ion, which have an effect of removing and deactivating floating fungi, floating viruses, and the like in air, also yield an additional effect of, for example, removing bacteria in a plant cultivation environment.

(Effect)

As described earlier, a positive ion and a negative ion each generated by the ion generating device 40 promote growth of the plant 10. This allows an increase in harvest from the plant 10. This also allows the plant 10 to be cultivated in a shorter period. In addition, in a case where (i) the plant cultivation apparatus 1 is provided so that growth of the plant 10 is observed or viewed and (ii) the plant 10 is grown at a higher speed, a change in accordance with growth of the plant 10 can be made easily understandable.

### Embodiment 2

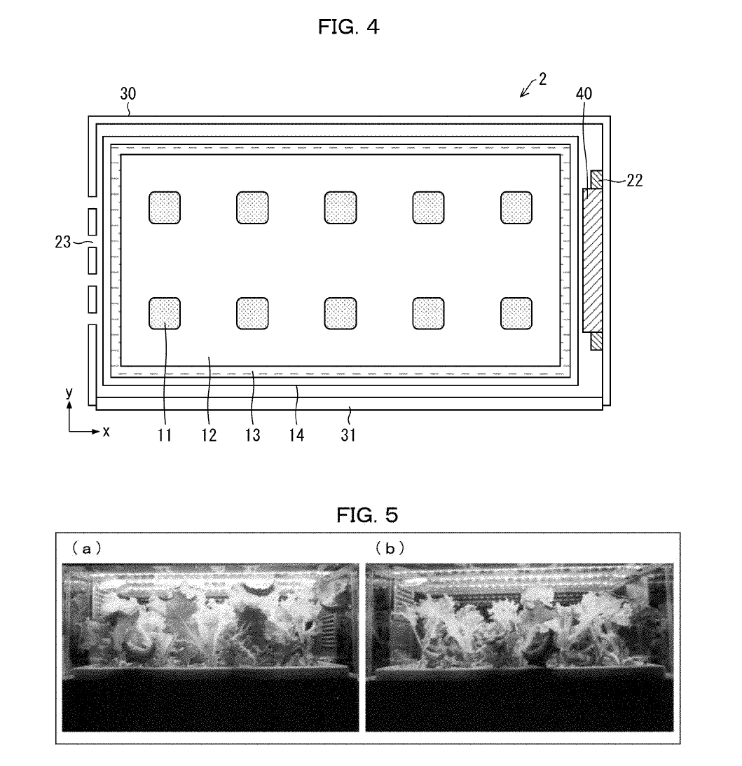

Another embodiment of the present invention is described below with reference to FIG. 4. Note that for convenience, members having functions identical to those of the respective members described in Embodiment 1 are given respective identical reference numerals, and a description of those members is omitted here.

FIG. 4 is a top cross-sectional view schematically illustrating an arrangement of a plant cultivation apparatus 2 in accordance with Embodiment 2 of the present invention. The plant cultivation apparatus 2 is identical to the plant cultivation apparatus 1 in accordance with Embodiment 1 except for placement of the ion generating device 40.

Thus, the following description discusses only (i) placement of an ion generating device 40 of the plant cultivation apparatus 2 and (ii) an effect that is yielded by a change in placement of the ion generating device 40.

According to the plant cultivation apparatus 1 in accordance with Embodiment 1, the ion generating device 40 is provided on the wall surface of the case 30 which wall surface faces in the y-axis negative direction and so as to be parallel to the airflow F. In contrast, according to the plant cultivation apparatus 2 in accordance with Embodiment 2, the ion generating device 40 is provided on a wall surface of a case 30 which wall surface faces in an x-axis negative direction (the wall surface of the case 30 on which wall surface an air sending device 22 is provided), is orthogonal to a direction in which an airflow F takes place, and is located upstream of the airflow F. According to the plant cultivation apparatus 2, as in the case of the plant cultivation apparatus 1, the ion generating device 40 generates more positive ions and more negative ions as the air sending device 22 produces the airflow F at a higher speed, and an inside of the case 30 has a positive ion concentration of not less than 1,000,000 ions/cm³ and a negative ion concentration of not less than 1,000,000 ions/cm³.

According to the plant cultivation apparatus 2, unlike the plant cultivation apparatus 1, the ion generating device 40 is located upstream of the airflow F. A positive ion and a negative ion each generated by the ion generating device 40 are easily carried on the airflow F and more uniformly diffused throughout the inside of the case 30. Thus, according to the plant cultivation apparatus 2, it is possible to more uniformly apply oxidative stress to a plurality of plants 10 and consequently to more uniformly promote growth of the plurality of plants 10.

Further, air around the ion generating device 40 is moved away from the ion generating device 40 by the airflow

F. This allows the ion generating device 40 to efficiently supply a positive ion and a negative ion.

According to the plant cultivation apparatus 2, the ion generating device 40 is provided in a vicinity of the air sending device 22, which produces the airflow F. Thus, even in a case where the airflow F in the plant cultivation apparatus 1 and the airflow F in the plant cultivation apparatus 2 are identical in speed, a positive ion and a negative ion are more easily carried on the airflow F in the plant cultivation apparatus 2 than in the plant cultivation apparatus 1. Thus, the plant cultivation apparatus 2 allows more effective positive and negative ion concentration diffusion than the plant cultivation apparatus 1.

### Embodiment 3

A specific example of the present invention is described below with reference to FIG. 1 and FIGS. 15 through 17. Note that for convenience, members having functions identical to those of the respective members described in Embodiments 1 and 2 are given respective identical reference numerals, and a description of those members is omitted here.

(Experimental Conditions)

In order to observe an effect that is yielded by a positive ion and a negative ion each of which is generated by an ion generating device 40, the present example used (i) a plant cultivation apparatus A corresponding to the plant cultivation apparatus 1 and (ii) a plant cultivation apparatus B obtained by removing the ion generating device 40 from the plant cultivation apparatus 1, and carried out comparative experiments in which capillary hydroponic cultivation is carried out with respect to the plants 10 as illustrated in FIG. 1 under the following conditions. Note that experimental conditions of the two plant cultivation apparatuses A and B differ merely in whether the ion generating device 40 is present or absent.

Plant cultivation apparatus A: “Green Farm UH-A01E”, which is a hydroponic cultivation apparatus sold by UING Corporation, was provided with the ion generating device 40 and driven, as in the plant cultivation apparatus 1 illustrated in FIG. 1.

Plant cultivation apparatus B: “Green Farm UH-A01E” was used as it was.

Plant 10: lettuce, whose variety is Gentilina Green and whose seed is sold by UING Corporation

Sponge 11, float 12, and hydroponic liquid vessel 14: a sponge, a float, and a hydroponic liquid vessel each attached to “Green Farm UH-A01E”

Hydroponic liquid 13: an approximately 133-fold diluted solution obtained by diluting, with distilled water, a liquid fertilizer attached to “Green Farm UH-A01E”

Cultivation period: 25 days

Number of times of cultivation: 3

Illumination pattern: Lights were turned off for the first three days (72 consecutive hours). For 22 days after the first three days, of the 24 hours, the lights were turned on in the daytime (6:00-22:00), whereas the lights were turned off in the nighttime (0:00-6:00 and 22:00-0:00).

Thinning: 15 seeds of the plant 10 were sowed. On the 9th day of cultivation of the plant 10, thinning was carried out with 10 individuals left.

(Observation and Measurement)

An influence of a positive ion and a negative ion on the plant 10 was observed and measured as below.

Visual observation during cultivation: During the cultivation period, an above-ground part of the plant 10 was visually observed every day.

Bacterial cultivation of hydroponic liquid: During the cultivation period, every 5 days, the hydroponic liquid 13 was partially collected so as to be cultured on an LB medium, at 37° C., in a dark place, and for 24 hours.

Visual observation during harvesting: After the cultivation period, each individual plant 10 was harvested by being divided into an above-ground part and a root. Then, the above-ground part and the root of the each individual plant 10 thus harvested were visually observed.

Measurement of fresh weight: Respective fresh weights of the above-ground part and the root of the each individual plant 10 harvested were measured.

Measurement of length: A maximum leaf length of the above-ground part of the each individual plant 10 harvested and a maximum root length of the root of the each individual plant 10 harvested were measured.

Measurement of number of leaves: The number of leaves of the above-ground part of the each individual plant 10 harvested was counted.

Measurement of leaf color value: Respective amounts of chlorophyll a and chlorophyll b each contained in the above-ground part of the each individual plant 10 harvested were measured.

Measurement of dry weight: The above-ground part and the root of the each individual plant 10 harvested were dried, and respective dry weights of the above-ground part and the root of the each individual plant 10 were measured.

Component measurement: Respective weights of nitrate ion (NO₃⁻) and oxalic acid each contained per dry weight of the above-ground part of the each individual plant 10 harvested were measured.

(Experimental Results)

(a) of FIG. 5 is a copy of a photograph showing a state of the plant 10 in the plant cultivation apparatus A (provided with the ion generating device 40) on the 25th day of the cultivation period, and (b) of FIG. 5 is a copy of a photograph showing a state of the plant 10 in the plant cultivation apparatus B (provided with no ion generating device 40) on the 25th day of the cultivation period.

According to the visual observation during cultivation, in each of the comparative experiments carried out three times, the plant 10 which was being cultivated in the plant cultivation apparatus A was larger in leaf, more shiny in leaf, and more favorable in entire growth than the plant 10 which was being cultivated in the plant cultivation apparatus B (see FIG. 5). Thus, growth of the plant 10 is considered to have been promoted by a positive ion and a negative ion each generated by the ion generating device 40.

According to bacterial cultivation of the hydroponic liquid, in each of the comparative experiments carried out three times, on the LB medium to which the hydroponic liquid 13 which had been collected from the plant cultivation apparatus A was applied, clearly fewer colonies were formed than on the LB medium to which the hydroponic liquid 13 which had been collected from the plant cultivation apparatus B was applied. Thus, it is estimated that an amount of bacteria contained in the hydroponic liquid 13 was reduced by causing a positive ion and a negative ion each generated by the ion generating device 40 to remove and deactivate floating fungi, floating viruses, and the like in air. Alternatively, a positive ion and a negative ion might have directly acted on the bacteria contained in the hydroponic liquid 13.

(a) of FIG. 6 is a copy of a photograph showing a root of the plant 10 in the plant cultivation apparatus A, and (b) of FIG. 6 is a copy of a photograph showing a root of the plant 10 in the plant cultivation apparatus B.

According to the visual observation during harvesting, in each of the comparative experiments carried out three times, the plant 10 which had been cultivated in the plant cultivation apparatus A was better in color, larger in leaf, taller in above-ground part, and, as illustrated in FIG. 6, better in root development than the plant 10 which had been cultivated in the plant cultivation apparatus B. The above-described visual observation during cultivation and the above-described visual observation during harvesting were supported by measurement of a maximum leaf length, the number of leaves, a fresh weight of an above-ground part, a dry weight of the above-ground part, a root length, a fresh weight of a root, a dry weight of the root, and a leaf color value.

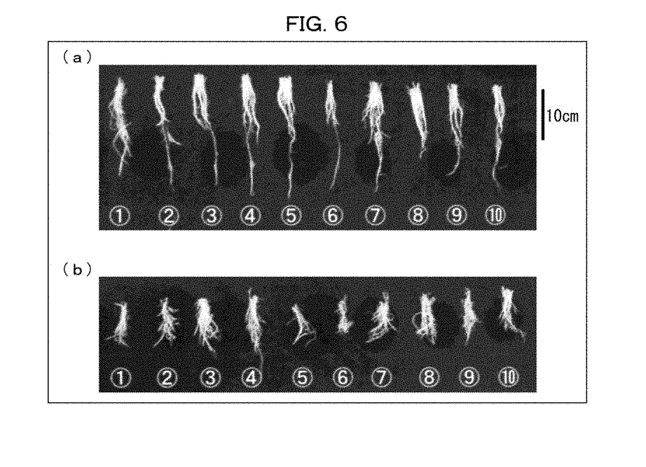

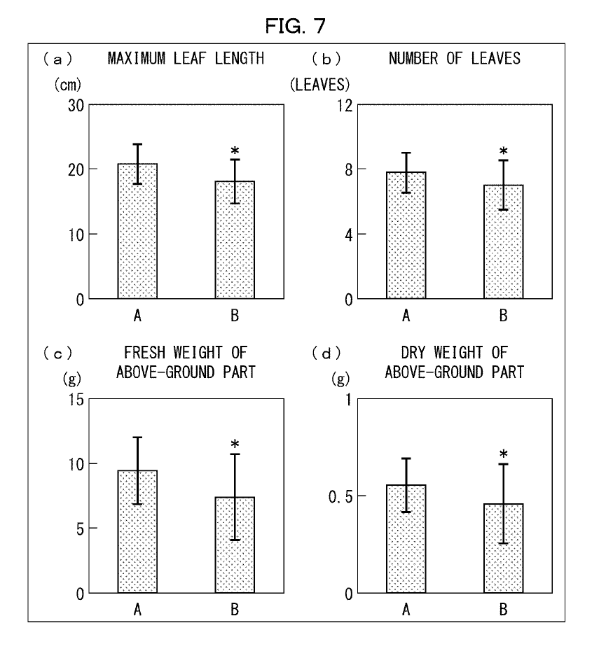

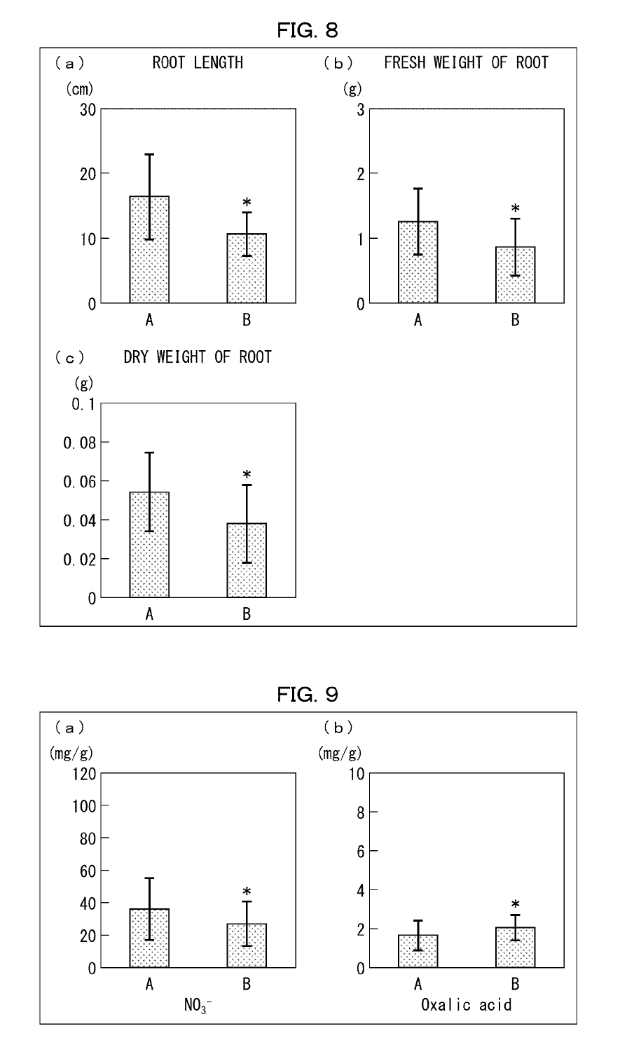

FIG. 7 has bar graphs showing averages and deviations of (a) a maximum leaf length, (b) the number of leaves, (c) a fresh weight of an above-ground part, and (d) a dry weight of the above-ground part of each individual plant 10 harvested in the first through third comparative experiments. FIG. 8 has bar graphs showing averages and deviations of (a) a root length, (b) a fresh weight of a root, and (c) a dry weight of the root of the each individual plant 10 harvested in the first through third comparative experiments. In each of FIGS. 7 and 8, the graph on the left shows a result of measurement on the plant 10 cultivated in the plant cultivation apparatus A, whereas the graph on the right shows a result of measurement on the plant 10 cultivated in the plant cultivation apparatus B. “*” indicates that there is a significant difference (P<0.05).

As shown in FIG. 7 and FIG. 8, for each of the respective fresh weights of the above-ground part and the root, the respective dry weights of the above-ground part and the root, the maximum leaf length, and the maximum root length, the plant 10 cultivated in the plant cultivation apparatus A showed a greater value than the plant 10 cultivated in the plant cultivation apparatus B.

According to a t-test, the above result was significant with a significance probability of 5% in terms of the maximum leaf length, the number of leaves, the fresh weight of the above-ground part, the dry weight of the above-ground part, the root length, the fresh weight of the root, and the dry weight of the root.

According to the measurement of the leaf color value, also for the contained amounts of the chlorophyll a and the chlorophyll b, the plant 10 cultivated in the plant cultivation apparatus A showed a slightly greater value than the plant 10 cultivated in the plant cultivation apparatus B (this is not shown in data).

Thus, it can be concluded that growth of the plant 10 was promoted by generation of a positive ion and a negative ion by an ion generating device.

FIG. 9 has bar graphs showing averages and deviations of weights of (a) nitrate ion (NO₃⁻) and (b) oxalic acid each contained per dry weight of the plant 10. In each of (a) and (b) of FIG. 9, the graph on the left shows a result of measurement on the plant 10 harvested from the plant cultivation apparatus A, whereas the graph on the right shows a result of measurement on the plant 10 harvested from the plant cultivation apparatus B. “*” indicates that there is a significant difference (P<0.05).

As shown in FIG. 9, for nitrate ion, the plant 10 cultivated in the plant cultivation apparatus A showed a greater value than the plant 10 cultivated in the plant cultivation apparatus B. Meanwhile, for oxalic acid, the plant 10 cultivated in the plant cultivation apparatus A showed a smaller value than the plant 10 cultivated in the plant cultivation apparatus B. According to the t-test, results for nitrate ion and oxalic acid were significant with a significance probability of 5%. Further, according to a one-side F test, a result for nitrate ion was also significant with a significance probability of 5%.

(RNA Sequence Analysis)

In order to investigate a cause of a change in amount of growth of the plant 10 (lettuce (variety: Gentilina Green)) influenced by a positive ion and a negative ion each generated by the ion generating device 40, the present example used (i) the plant cultivation apparatus A corresponding to the plant cultivation apparatus 1 and (ii) the plant cultivation apparatus B obtained by removing the ion generating device 40 from the plant cultivation apparatus 1, and carried out RNA sequence analysis of the plant 10 under the following conditions. Note that experimental conditions of the two plant cultivation apparatuses A and B differ merely in whether the ion generating device 40 is present or absent.

(Experimental Conditions)

A sample was collected, by use of a leaf punch (φ: 12 mm), from a leaf of an above-ground part of each individual plant 10 of the 24th day of the cultivation period, and RNA of the leaf of the above-ground part of the each individual plant 10 was extracted by use of RNeasy Plant Mini Kit (manufactured by QIAGEN). Then, library preparation was carried out by use of SureSelect. Strand-Specific RNA Library Prep for Illumina Multiplexed Sequencing (manufactured by Agilent Technologies), and the RNA sequence analysis was carried out by use of MiSeq (manufactured by Illumina, Inc.).

(Result of Analysis)

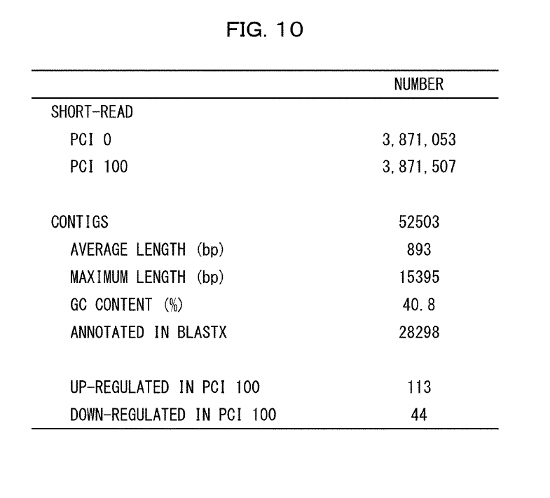

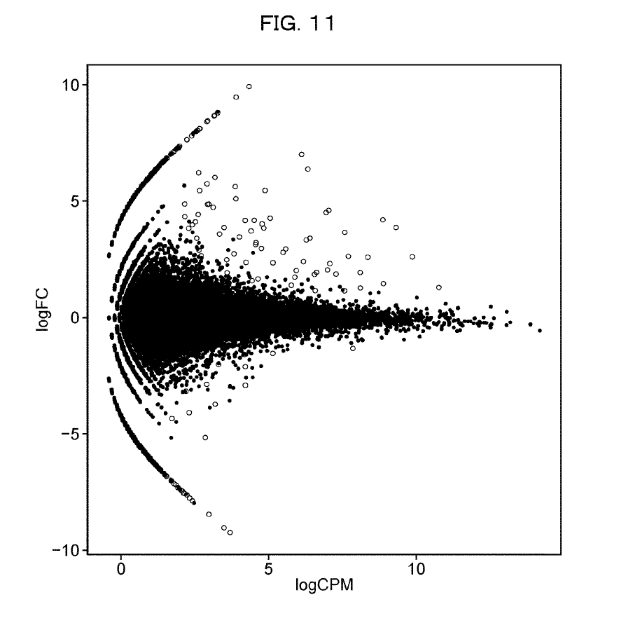

FIG. 10 shows a result of RNA sequencing of a leaf of the plant 10 cultivated in each of the plant cultivation apparatus A and the plant cultivation apparatus B. “PCI plot 100 (hereinafter referred to as “PCI 100”)” shows a result for a plant cultivated in the plant cultivation apparatus A of an Example, and “PCI plot 0 (hereinafter referred to as “PCI 0”)” shows a result for a plant cultivated in the plant cultivation apparatus B of a Comparative Example. FIG. 11 shows a result of an MA plot showing a difference in gene expression level between the leaf of the plant 10 cultivated in the plant cultivation apparatus A and the leaf of the plant 10 cultivated in the plant cultivation apparatus B. log CPM, which is a horizontal axis, is a logarithm which is obtained by relatively calculating the number of short reads, involved in contigs, out of 1,000,000 short reads and whose base is 2. A contig that has a greater value of log CPM indicates that the contig is constantly expressed at a high level in the plant 10. Meanwhile, a contig that has a smaller value of log CPM indicates that the contig is originally expressed at a low level in the plant 10. log FC, which is a vertical axis, is a logarithm whose base is 2. log FC is an indicator showing a difference in contig expression level between the plant cultivated in the plant cultivation apparatus A of an Example and the plant cultivated in the plant cultivation apparatus B of a Comparative Example. A contig whose log FC has a positive value means that a contig expression level was made higher (i.e., a contig expression level was made higher by positive and negative ion irradiation) in the plant cultivated by the plant cultivation apparatus A than in the plant cultivated by the plant cultivation apparatus B. A contig whose log FC has a negative value means that a contig expression level made lower (i.e., a contig expression level was made lower by positive and negative ion irradiation) in the plant cultivated by the plant cultivation apparatus A than in the plant cultivated by the plant cultivation apparatus B. Each plot indicates a corresponding contig. A white plot indicates a contig whose expression level was increased or decreased significantly (P<0.05) by positive and negative ion irradiation. A black plot indicates a contig whose expression level did not significantly vary by positive and negative ion irradiation.

As shown in FIG. 10, a result of the RNA sequence analysis shows that 52,503 contig sequences were obtained (see “CONTIGS” of FIG. 10), and annotation was added to 28,298 contigs of those contig sequences by a BLAST program (see “ANNOTATED IN BLASTX” of FIG. 10). Further as shown in FIGS. 10 and 11, as compared with the plant 10 in the plant cultivation apparatus B, the plant 10 in the plant cultivation apparatus A had (i) 113 contigs whose expression level was significantly increased (see “UP-REGULATED” of FIG. 10) and (ii) 44 contigs whose expression level was decreased (see “DOWN-REGULATED” of FIG. 10).

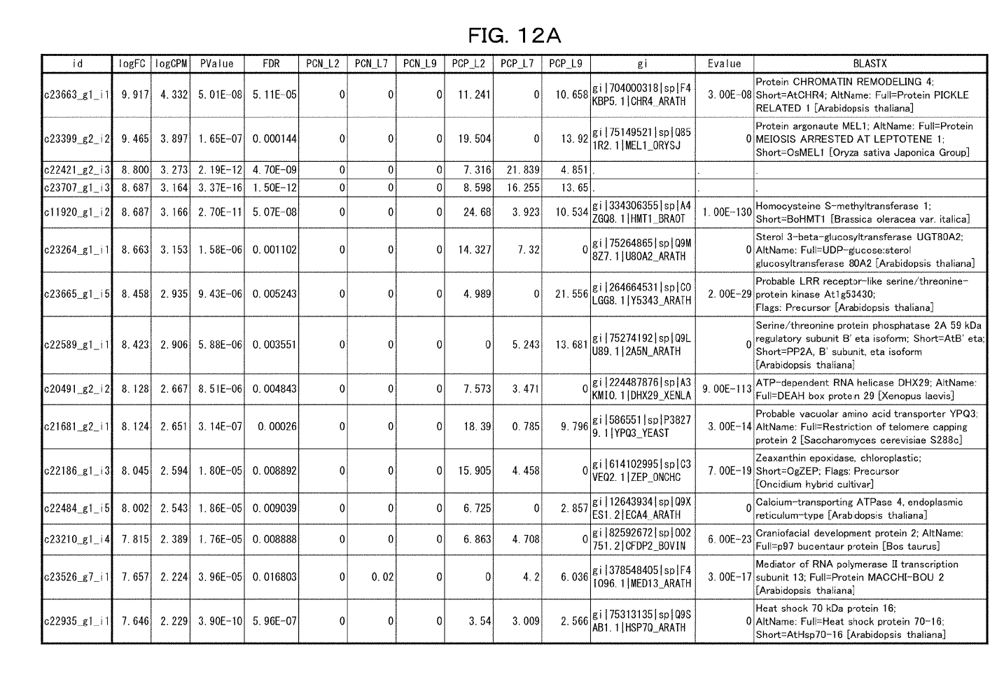

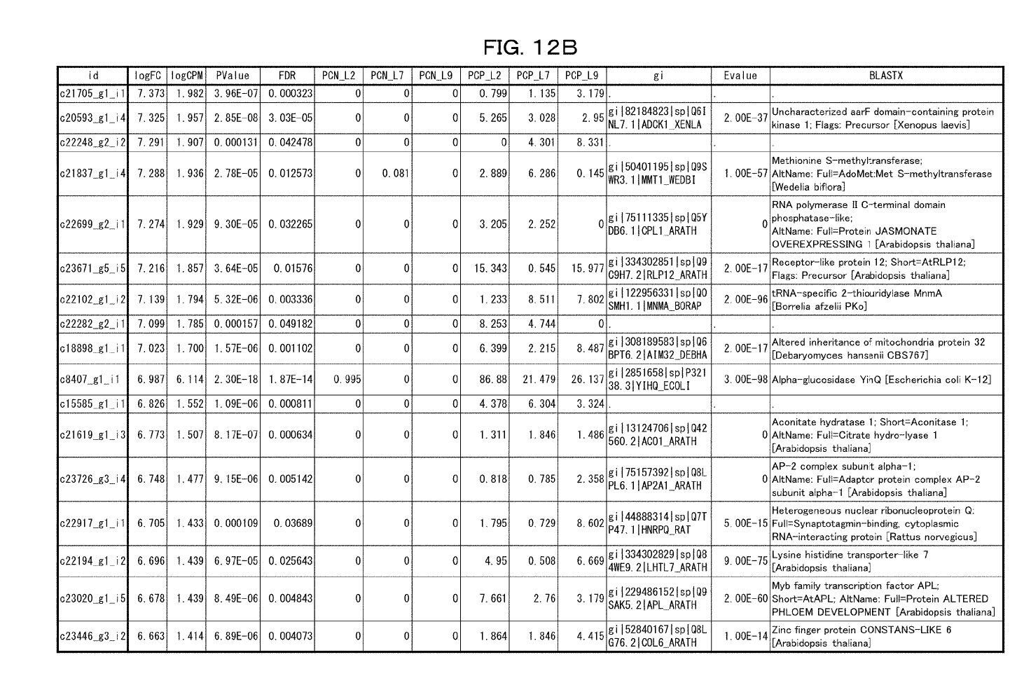

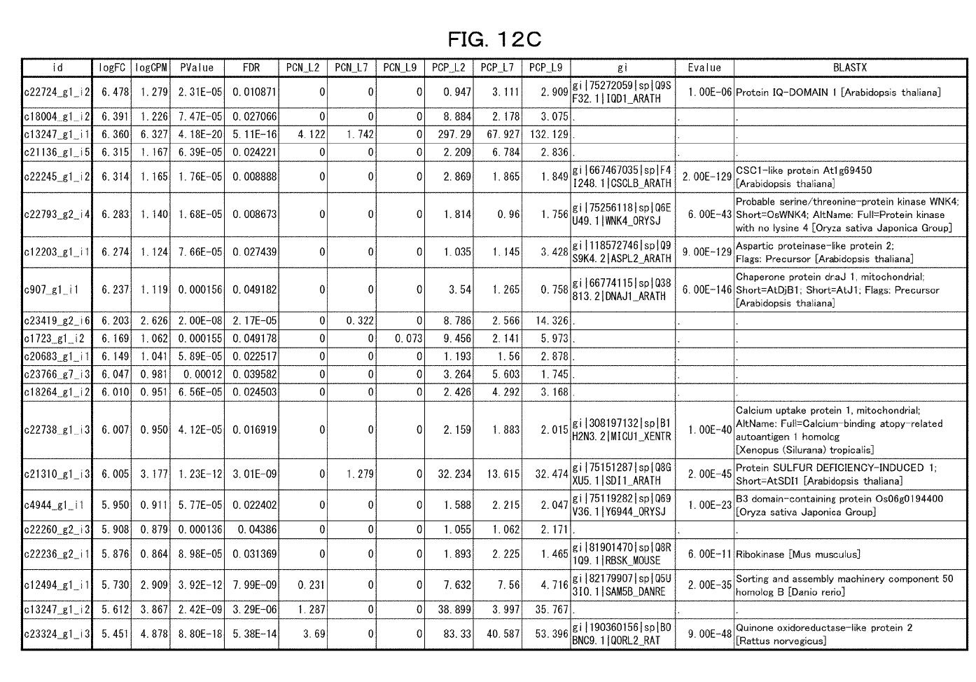

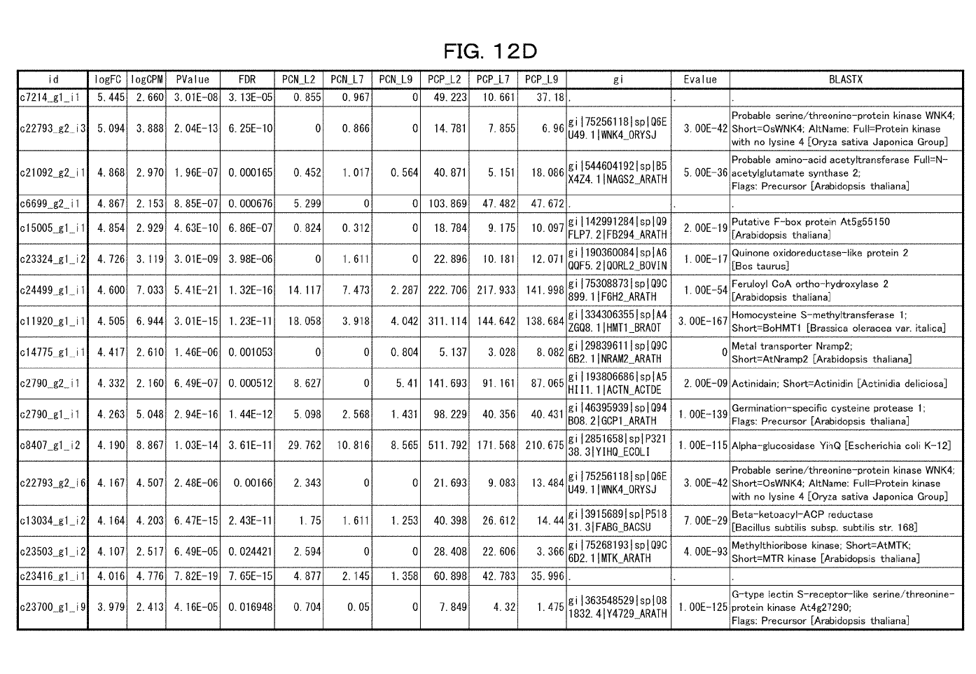

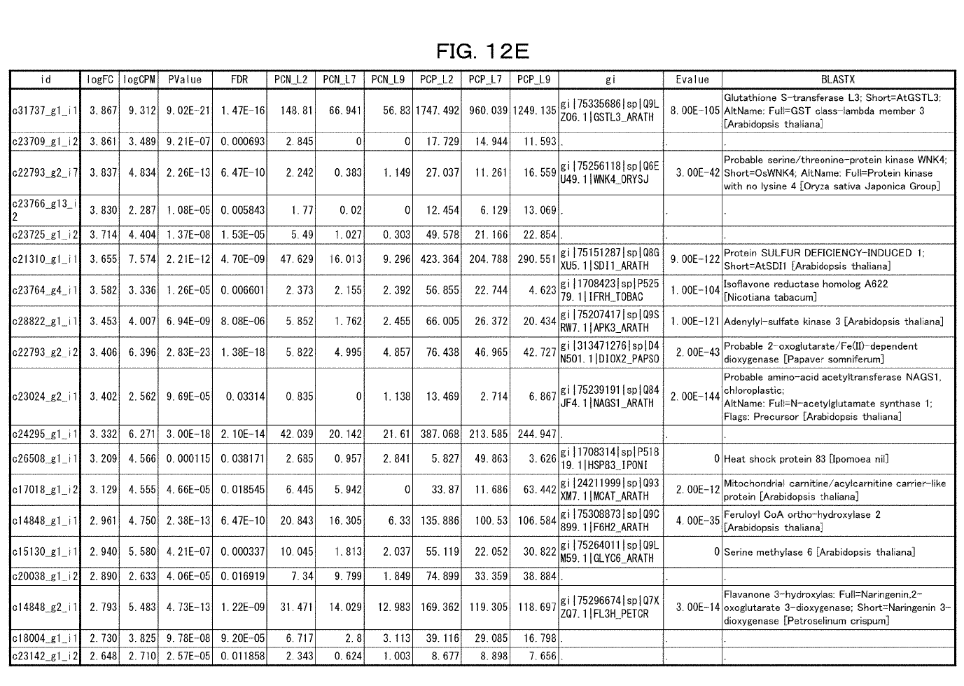

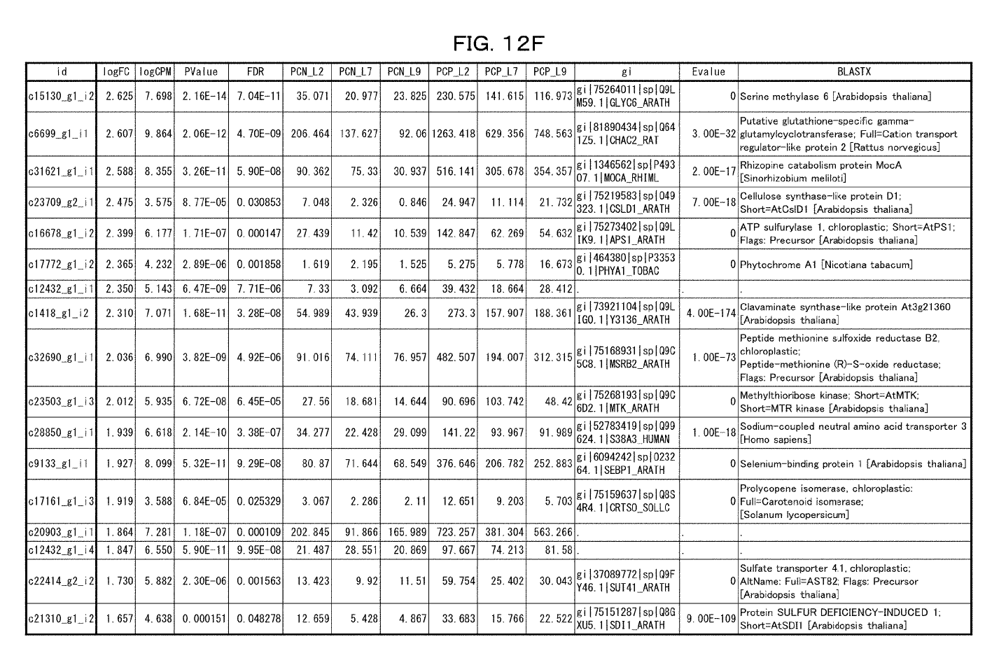

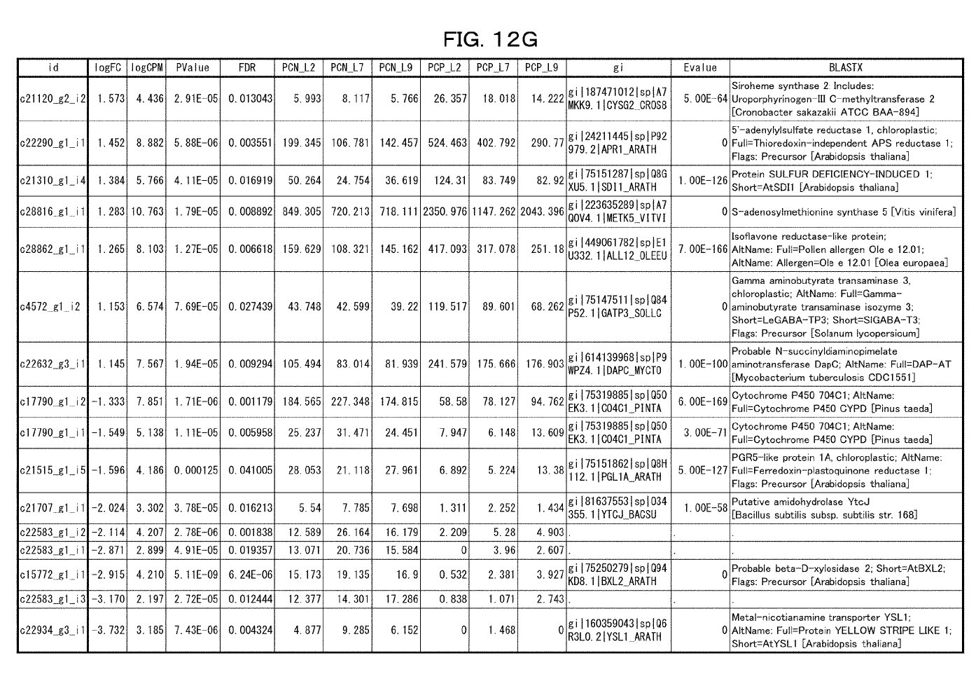

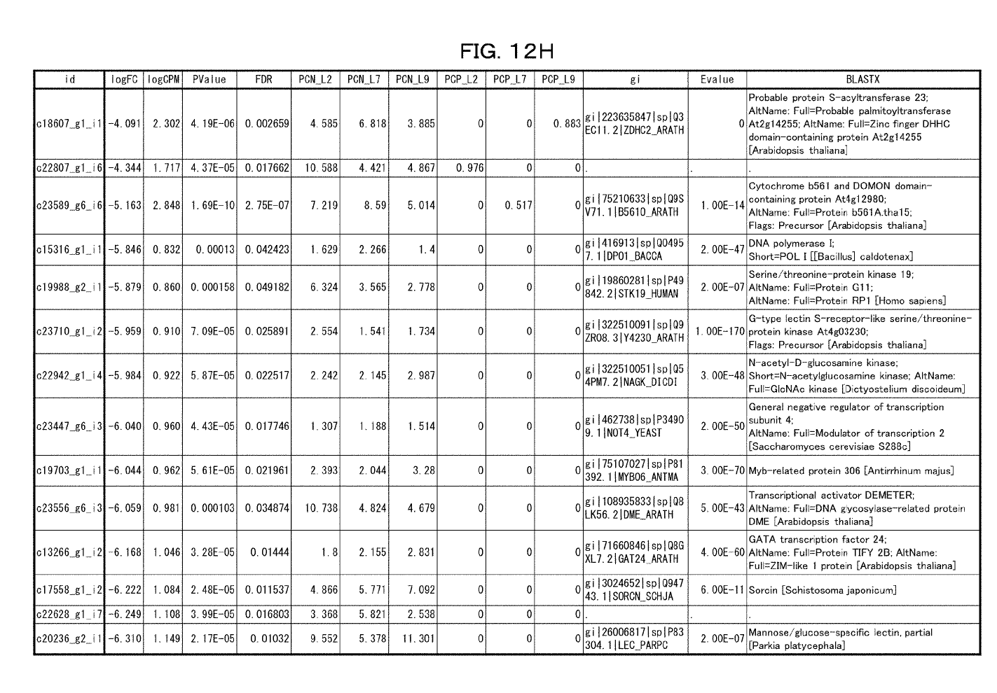

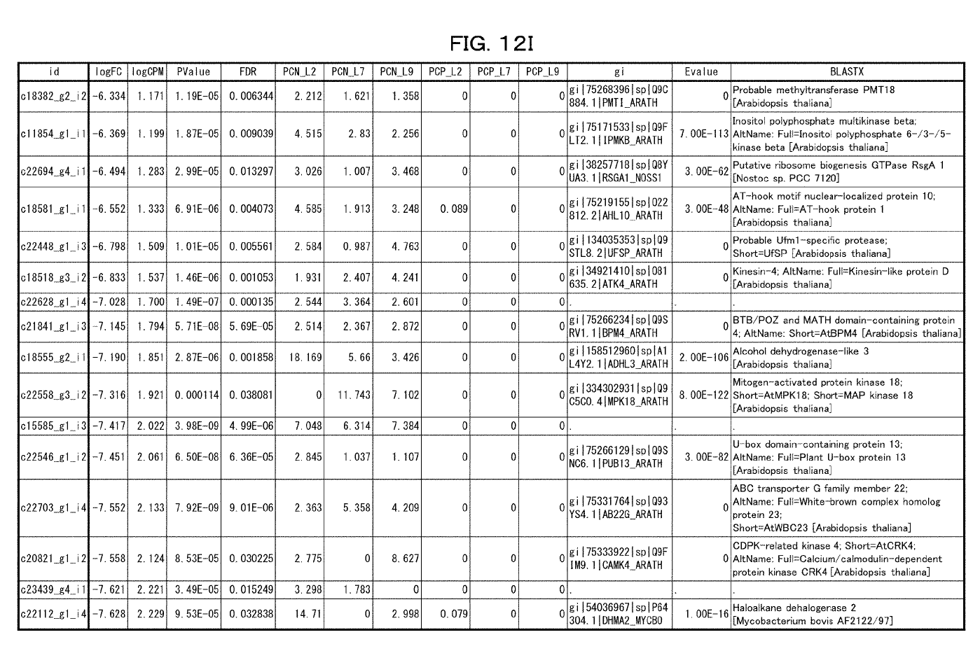

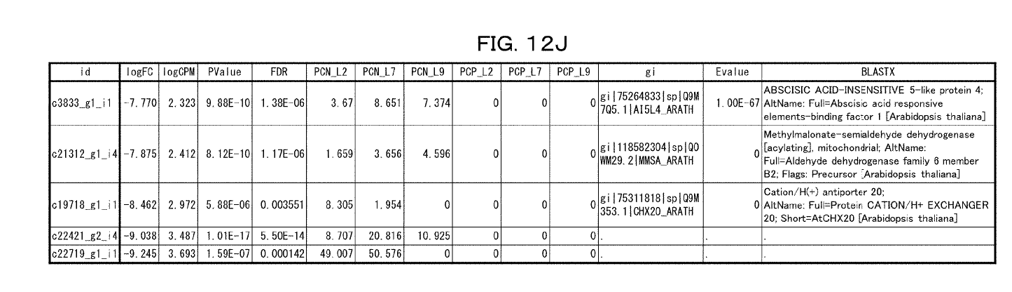

FIGS. 12A through 12J are each a list of patterns of expression of contigs obtained by RNA sequencing carried out by use of a leaf of the plant 10 in the plant cultivation apparatus A and a leaf of the plant 10 in the plant cultivation apparatus B and (ii) results of annotation added by a BLAST program to the contigs thus obtained. The following are meanings of numerical values shown in FIGS. 12A through 12J.
log FC: an indicator showing a difference in contig expression level
log CPM: indicator of the number of reads involved in contigs
PValue (P value): an indicator of a significance level in a hypothesis test
FDR (false discovery rate): an indicator of a significance level in a multiple test
PCN_L2: the number of reads of each contig of the plant 10 in the plant cultivation apparatus B
PCN_L7: the number of reads of each contig of the plant 10 in the plant cultivation apparatus B
PCN_L9: the number of reads of each contig of the plant 10 in the plant cultivation apparatus B
PCP_L2: the number of reads of each contig of the plant 10 in the plant cultivation apparatus A
PCP_L7: the number of reads of each contig of the plant 10 in the plant cultivation apparatus A
PCP_L9: the number of reads of each contig of the plant 10 in the plant cultivation apparatus A
gi: a gene ID registered in NCBI
EValue (E value): an indicator of annotation by a BLAST program
BLASTX: a result of the annotation by the BLAST program

As shown in FIGS. 12A through 12J, out of genes whose expression level was further significantly changed in the plant 10 in the plant cultivation apparatus A (PCI 100) than in the plant 10 in the plant cultivation apparatus B (PCI 0), particularly a group of genes involved in sulfur metabolism was observed to change in expression by a positive ion and a negative ion each generated by the ion generating device 40.

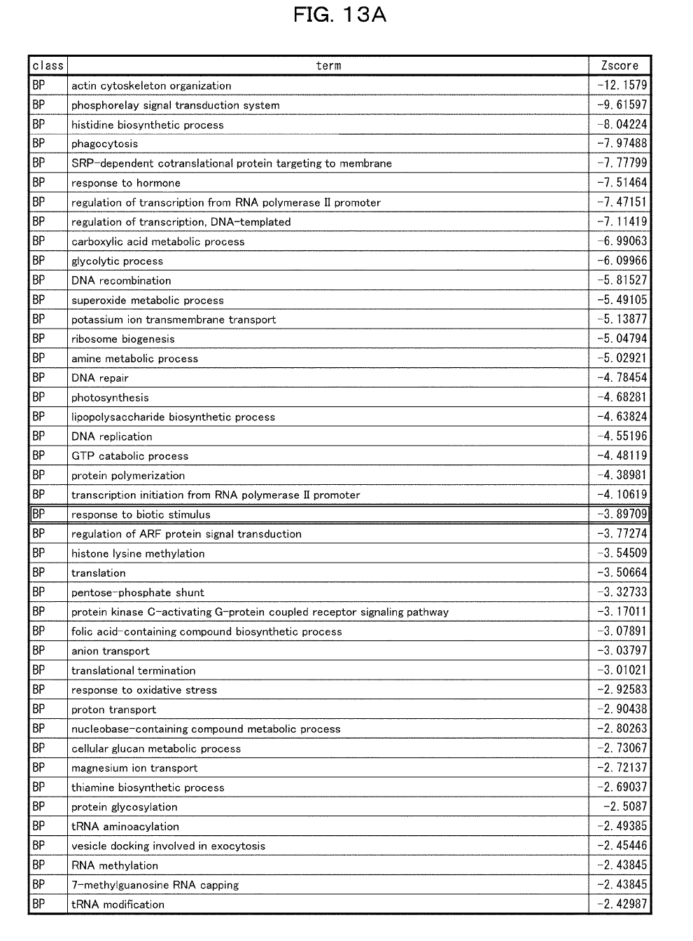

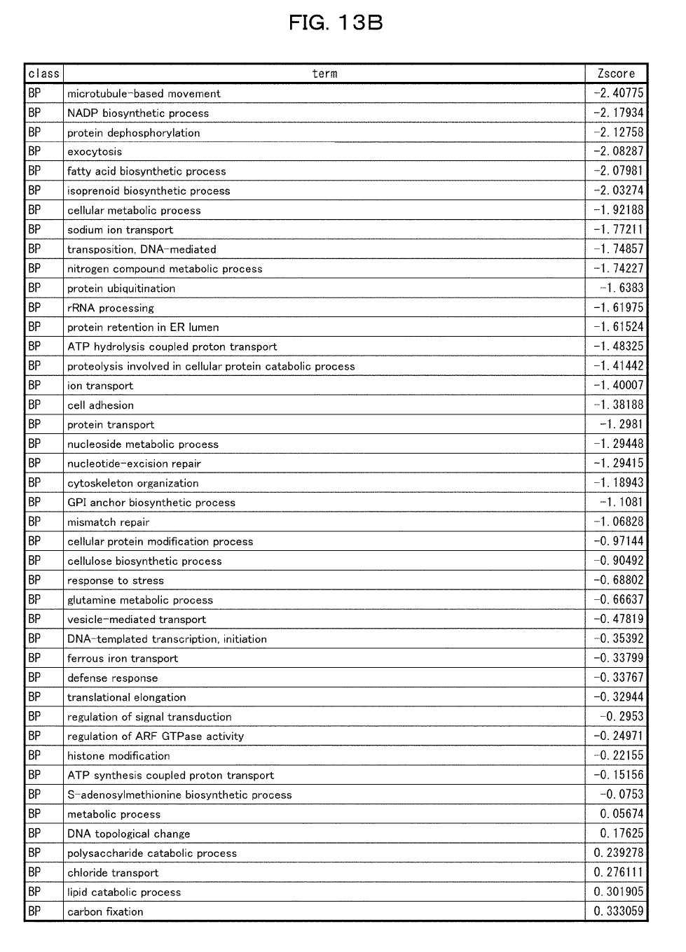

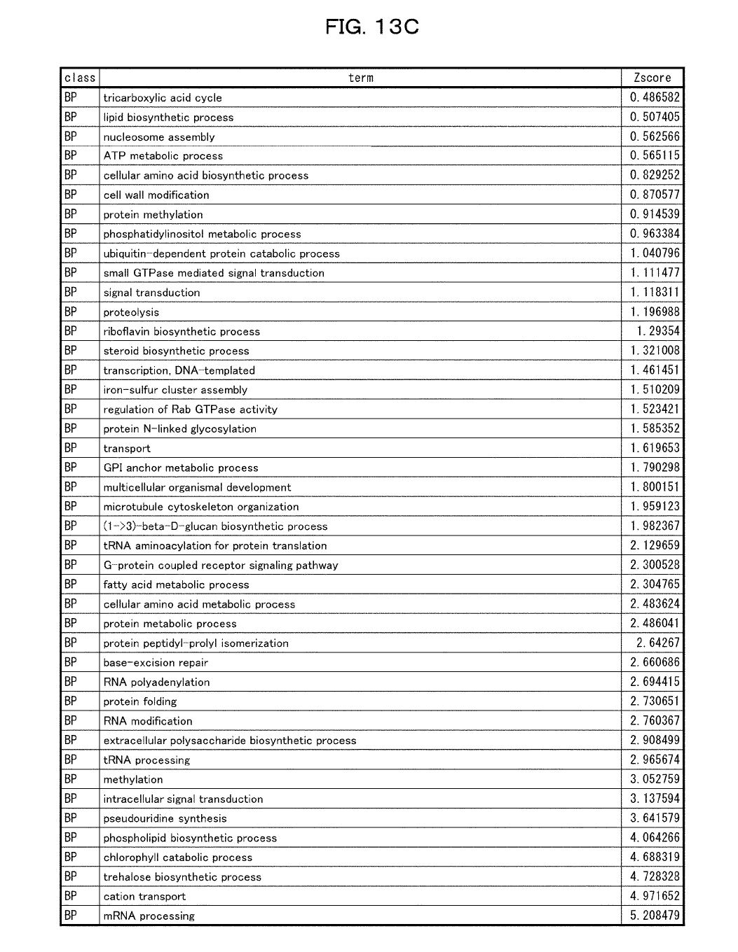

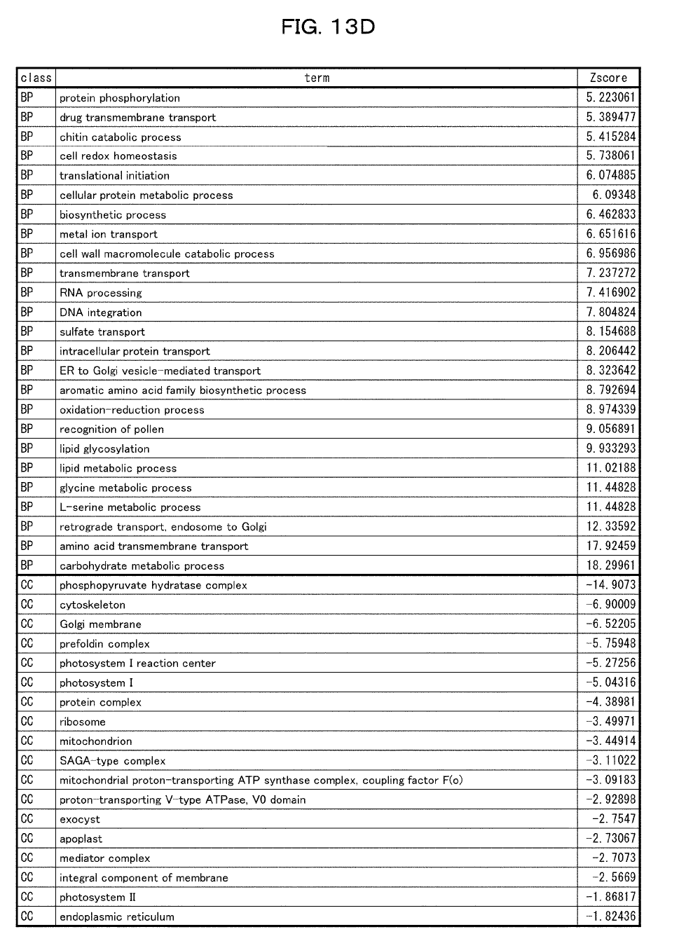

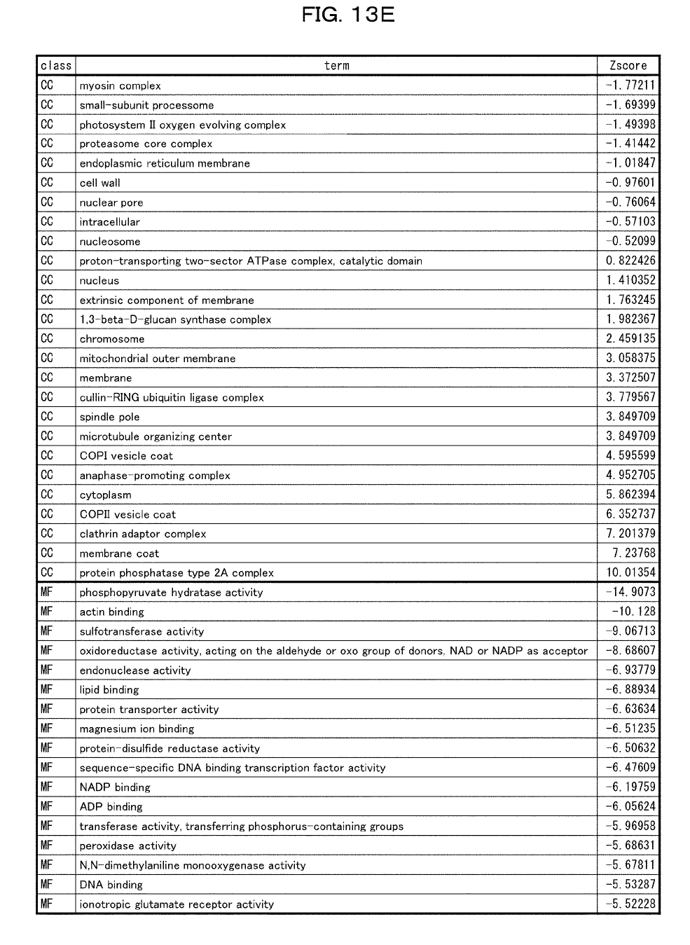

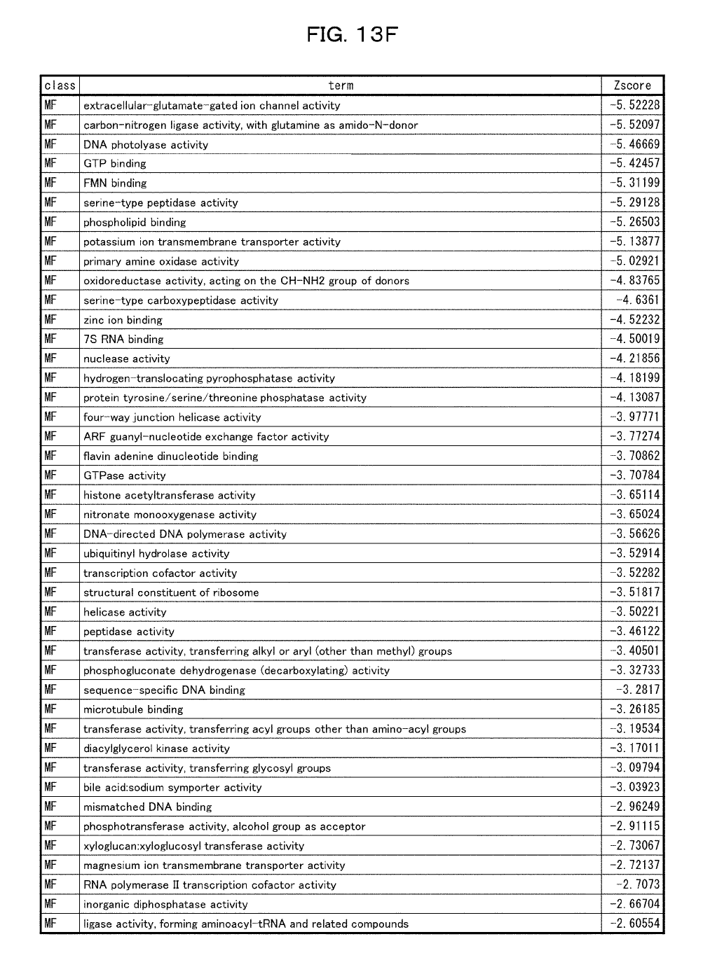

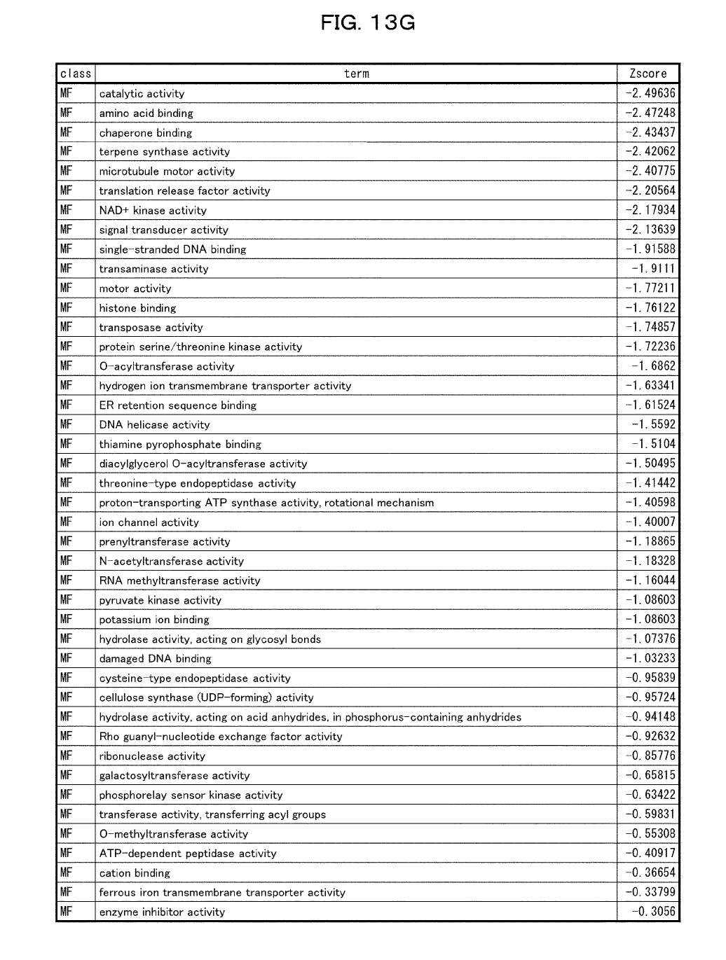

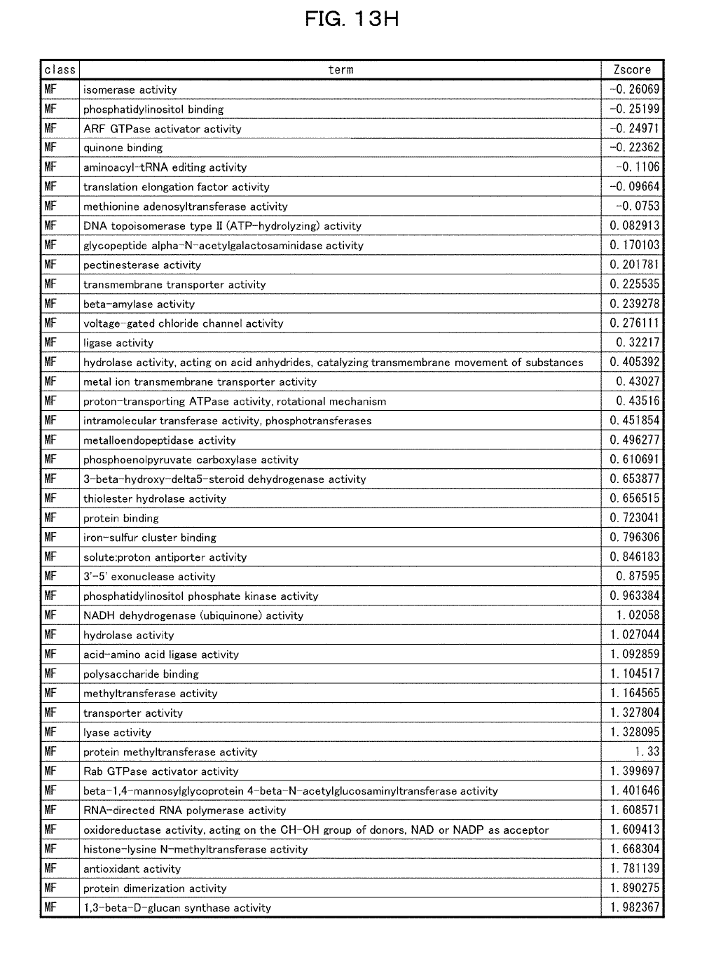

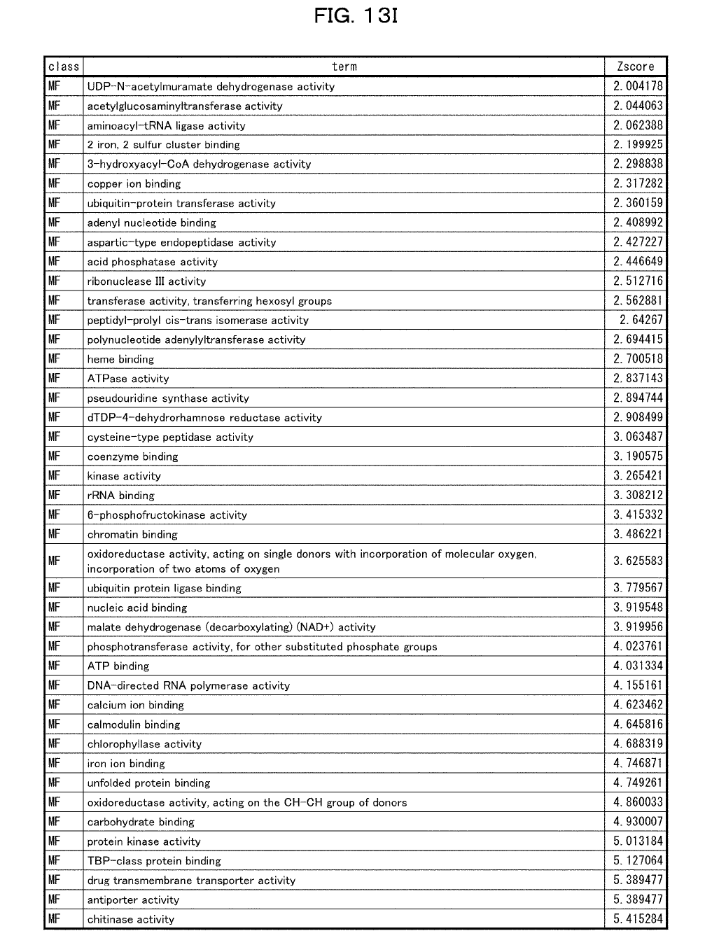

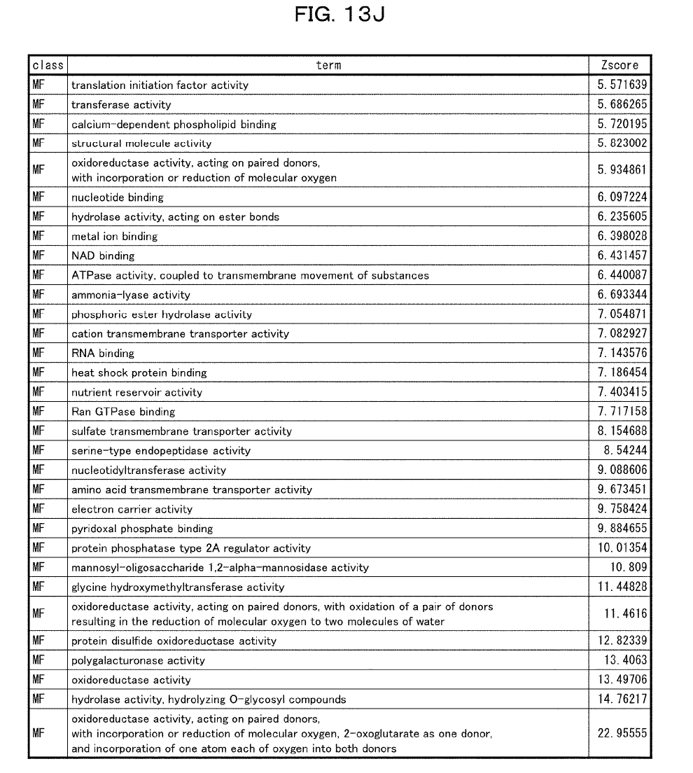

FIGS. 13A through 13J each show results of gene ontology enrichment analysis carried out based on a result of annotation added by a BLAST program to contigs identified by RNA sequencing carried out by use of a leaf of the plant 10 in the plant cultivation apparatus A and a leaf of the plant 10 in the plant cultivation apparatus B. Classes shown in FIGS. 13A through 13J are separated based on the following concept.
class BP: Biological Process
class CC: Cellular Component
class MF: Molecular Function

As shown in FIGS. 13A through 13J, the results of the gene ontology enrichment analysis reveal that a level of expression of genes related to “response to biotic stimulus (“RESPONSE TO BIOTIC STIMULUS” of FIG. 13A)” was decreased by −3.90 in terms of Z score in the plant 10 in the plant cultivation apparatus A.

(Metabolome Analysis)

In order to investigate a cause of a change in amount of growth of the plant 10 influenced by a positive ion and a negative ion each generated by the ion generating device 40, the present example used (i) the plant cultivation apparatus A corresponding to the plant cultivation apparatus 1 and (ii) the plant cultivation apparatus B obtained by removing the ion generating device 40 from the plant cultivation apparatus 1, and carried out metabolome analysis of the plant 10 under the following conditions. Note that experimental conditions of the two plant cultivation apparatuses A and B differ merely in whether the ion generating device 40 is present or absent.

(Experimental Conditions)

A sample was collected from a leaf of an above-ground part of each individual plant 10 (lettuce (variety: Gentilina Green)) of the 25th day of the cultivation period. To the sample, 500 μL of a methanol solution (50 μM) was added. Then, a resulting mixture was crushed, while being cooled, by use of a crusher (1500 rpm, 120 seconds×1 time). To the sample thus crushed, 500 μL of chloroform and 200 μL of Milli-Q water were added. Then, a resultant mixture was stirred and subjected to centrifugation (2,300×g, 4° C., 5 minutes). After the centrifugation, 400 μL of an aqueous layer was transferred into an ultrafiltration tube (Ultrafree-MC PLHCC, HMT, centrifugal filter unit 5 kDa). The aqueous layer was subjected to centrifugation (9,100×g, 4° C., 120 minutes) and subjected to an ultrafiltration treatment. A resultant filtrate was dried and solidified, and the dried and solidified filtrate was dissolved again in 50 μL of Milli-Q water. Then, a resultant solution was subjected to measurement of a cation mode and an anion mode of a capillary electrophoresis-time-of-flight mass spectrometer (CE-TOFMS).

The cation mode and the anion mode of the CE-TOFMS were measured under the following conditions.

(i) Cationic Metabolic Substance Measurement Condition (Cation Mode)

Device: Agilent CE-TOFMS system (Agilent Technologies)

Capillary: Fused silica capillary i.d. 50 μm×80 cm

Running buffer: Cation Buffer Solution (p/n: H3301-1001)

Rinse buffer: Cation Buffer Solution (p/n: H3301-1001)

Sample pouring: 50 mbar, 10 seconds

CE voltage: Positive, 27 kV

MS ionization: ESI Positive

MS capillary voltage: 4,000 V

MS scan range: m/z 50-1,000

Sheath liquid: HMT sheath liquid (p/n: H3301-1020)

(ii) Anionic Metabolic Substance Measurement Condition (Anion Mode)

Device: Agilent CE-TOFMS system (Agilent Technologies)

Capillary: Fused silica capillary i.d. 50 μm×80 cm

Running buffer: Anion Buffer Solution (p/n: H3302-1021)

Rinse buffer: Anion Buffer Solution (p/n: H3302-1021)

Sample pouring: 50 mbar, 25 seconds

CE voltage: Positive, 30 kV

MS ionization: ESI Negative

MS capillary voltage: 3,500 V

MS scan range: m/z 50-1,000

Sheath liquid: HMT sheath liquid (p/n: H3301-1020)

Peaks which had been detected by use of the CE-TOFMS and whose signal/noise (S/N) ratio was not less than 3 were automatically extracted by use of MasterHands ver.2.17.1.11 (developed by Keio University), which is automatic integration software. A mass-to-charge ratio (m/z), a peak area value, and a migration time (MT) of each of the peaks thus automatically extracted were obtained. The obtained peak area value was transformed into a relative area value based on the following Formula 3. Note that these pieces of data include data of adduct ions such as Na⁺ and K⁺, and data of fragment ions that are generated by, for example, dehydration and/or deammonium reaction. Thus, the data of these ions were removed, and the automatically extracted peaks were carefully examined. Based on values of m/z and MT, the respective automatically extracted peaks of the samples were compared with each other and sorted.

Relative area value=target peak area value/(area value of internal standard substance×sample amount) [Formula 3]

In accordance with values of m/z and MT of substances registered in an HMT metabolic substance library and in a Known-Unknown library, candidate compounds were narrowed down. The candidate compounds thus narrowed down were subjected to (i) calculation of a relative area value ratio between (a) a relative area value of the plant 10 in the plant cultivation apparatus B (PCI 0) and (b) a relative area value of the plant 10 in the plant cultivation apparatus A (PCI 100) and (ii) a Welch's t-test.

The above ratio between the relative area values and a result of the above t-test were drawn on a metabolic pathway map of metabolic substance quantitative data. A metabolic pathway was drawn by use of Visualization and Analysis of Networks containing Experimental Data (VANTED).

(Result of Analysis)

As a result of the metabolome analysis, the candidate compounds were given to 102 peaks (cation: 66 peaks, anion: 36 peaks) in accordance with the values of m/z and MT of the substances registered in the HMT metabolic substance library and in the Known-Unknown library.

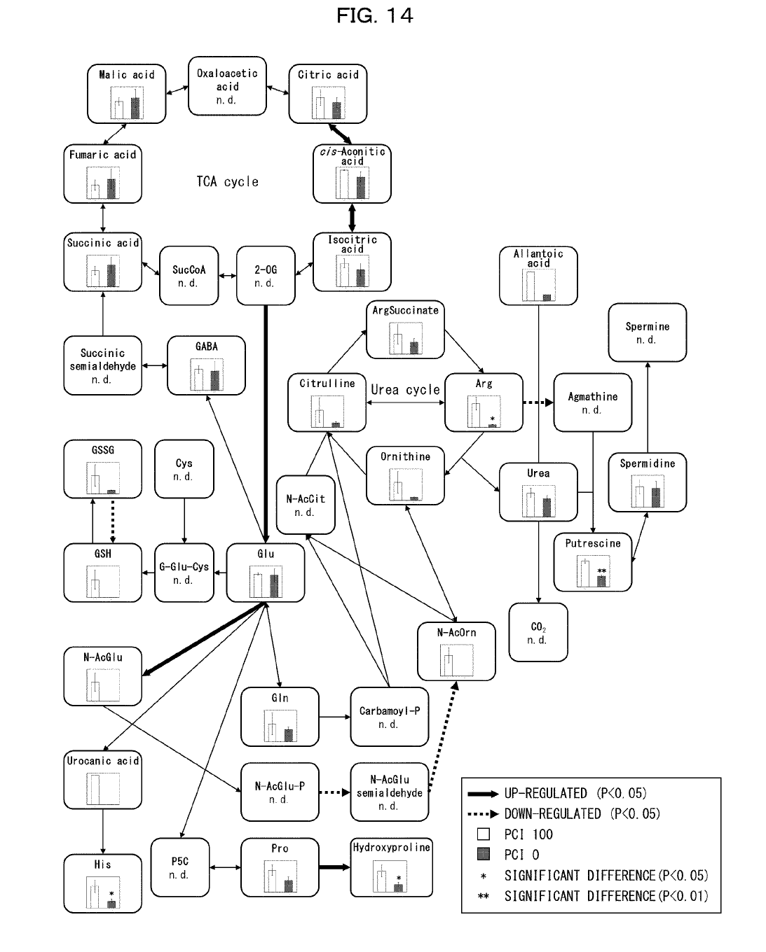

FIG. 14 is a view obtained by partially drawing, on a TCA cycle pathway and an urea cycle metabolic pathway, results of metabolome analysis carried out by use of a leaf of the plant 10 in the plant cultivation apparatus A (PCI 100) and a leaf of the plant 10 in the plant cultivation apparatus B (PCI 0). Bar graphs drawn in metabolic products indicate relative area values of the metabolic products of the plant cultivated by the plant cultivation apparatus A and the plant cultivated by the plant cultivation apparatus B.

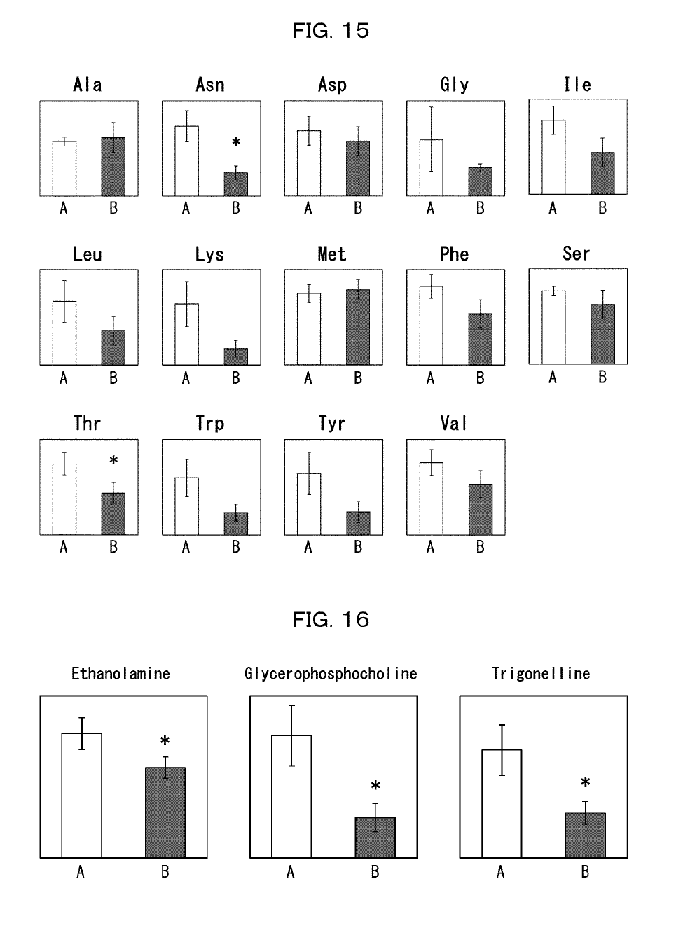

FIG. 15 shows, in terms of relative area values, results of analysis of amounts of accumulation of part of amino acids out of results of metabolome analysis carried out by use of a leaf of the plant 10 in the plant cultivation apparatus A (A) and a leaf of the plant 10 in the plant cultivation apparatus B (B). “*” indicates that there is a significant difference (P<0.05).

As shown in FIG. 15, for asparagine (Asn) and threonine (Thr), the plant 10 cultivated in the plant cultivation apparatus A showed a significantly greater value than the plant 10 cultivated in the plant cultivation apparatus B. Further, according to the t-test, the above result was significant with a significance probability of 5%.

FIG. 16 shows, in terms of relative area values, results of analysis of amounts of accumulation of metabolic substances, which have not been drawn on a metabolic pathway map, out of results of metabolome analysis carried out by use of a leaf of the plant 10 in the plant cultivation apparatus A (A) and a leaf of the plant 10 in the plant cultivation apparatus B (B). “*” indicates that there is a significant difference (P<0.05).

As shown in FIG. 16, for ethanolamine, glycerophosphocholine, and trigonelline, the plant 10 cultivated in the plant cultivation apparatus A showed a significantly greater value than the plant 10 cultivated in the plant cultivation apparatus B. Further, according to the t-test, the above result was significant with a significance probability of 5%.

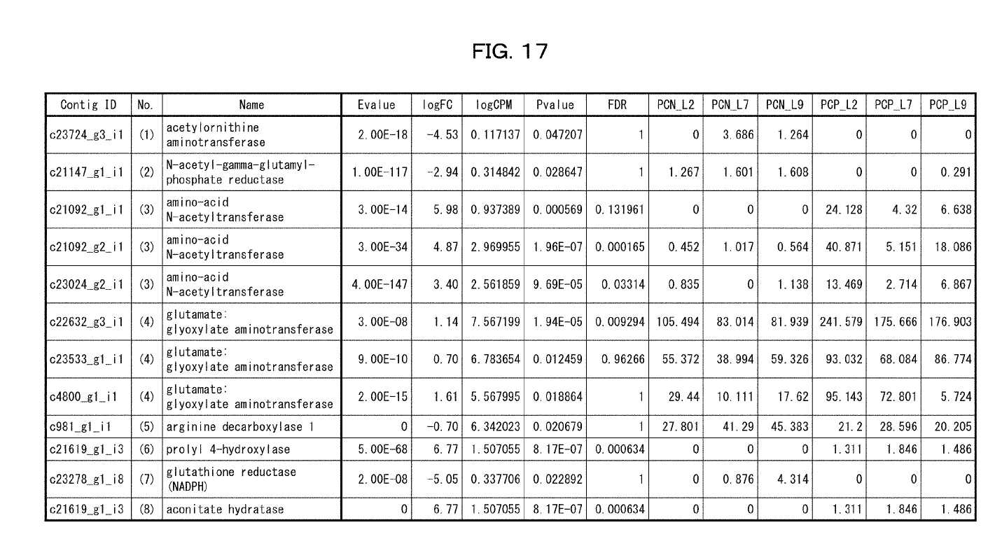

FIG. 17 is a list of contigs, which have been identified by the RNA sequencing, out of contigs corresponding to genes involved in biosynthesis of metabolic products shown in FIG. 14. In FIG. 17, (1) shows a gene involved in a reaction indicated by a dotted line arrow, in FIG. 14, extending from N-acetylglutamate semialdehyde to N—AcOrn, (2) shows a gene involved in a reaction indicated by a dotted line arrow, in FIG. 14, extending from N—AcGlu-P to N-acetylglutamate semialdehyde, (3) shows a gene involved in a reaction indicated by a bold line arrow, in FIG. 14, extending from Glu to N—AcGlu, (4) shows a gene involved in a reaction indicated by a bold line arrow, in FIG. 14, extending from 2-OG to Glu, (5) shows a gene involved in a reaction indicated by a dotted line arrow, in FIG. 14, extending from Arg to agmatine, (6) shows a gene involved in a reaction indicated by a bold line arrow, in FIG. 14, extending from Pro to hydroxyproline, (7) shows a gene involved in a reaction indicated by a dotted line arrow, in FIG. 14, extending from GSSG to GSH, (8) shows a gene involved in each of (i) a reaction indicated by a bold line two-headed arrow, in FIG. 14, extending from citric acid to cis-aconitic acid and (ii) a reaction indicated by a bold line two-headed arrow, in FIG. 14, extending from cis-aconitic acid to isocitric acid.

[Recap]

A plant cultivation method in accordance with a first aspect of the present invention for promoting growth of a plant, includes: a positive and negative ion irradiation step of irradiating the plant with a positive ion and a negative ion.

According to the plant cultivation method, a radical is produced from the positive ion and the negative ion with each of which the plant has been irradiated. It is estimated that the positive ion and the negative ion, and an action of the radical (e.g., oxidative stress caused by the radical) promote growth of the plant.

Since it is confirmed that neither a positive ion nor a negative ion adversely affects growth of a plant, it is unnecessary to strictly set a condition under which to irradiate the plant with the positive ion and the negative ion. This makes it possible to promote growth of the plant by a simple method.

A plant cultivation method in accordance with a second aspect of the present invention can be arranged, in the first aspect, to further include: an air sending step of producing an airflow so that the plant is laterally subjected to the airflow, the positive and negative ion irradiation step and the air sending step being simultaneously carried out.

According to the plant cultivation method, the positive ion and the negative ion with each of which the plant is irradiated in the positive and negative ion irradiation step are diffused by the airflow. Such diffusion allows a plurality of plants to be uniformly irradiated with positive ions and negative ions.

A plant cultivation method in accordance with a third aspect of the present invention can be arranged such that, in the second aspect, in the positive and negative ion irradiation step, the positive ion and the negative ion are each generated upstream of the airflow.

According to the plant cultivation method, the positive ion and the negative ion each generated upstream of the airflow are carried downstream of the airflow. Thus, the positive ion and the negative ion are more uniformly diffused. Such uniform diffusion allows a plurality of plants to be uniformly irradiated with positive ions and negative ions.

A plant cultivation method in accordance with a fourth aspect of the present invention can be arranged such that, in any one of the first through third aspects, the positive ion is an ion that consists mainly of H⁺(H₂O)ₘ (m is any natural number), and the negative ion is an ion that consists mainly of O₂⁻(H₂O)ₙ (n is any natural number).

According to the plant cultivation method, a hydroxyl radical, which is an active oxygen species, is produced from H⁺(H₂O)ₘ and O₂⁻(H₂O)ₙ.

A plant cultivation method in accordance with a fifth aspect of the present invention can be arranged such that, in any one of the first through fourth aspects, a space surrounding the plant has a positive ion concentration of not less than 1,000,000 ions/cm³ and a negative ion concentration of not less than 1,000,000 ions/cm³.

According to the plant cultivation method, it depends on a positive ion concentration and a negative ion concentration whether growth of a plant is promoted as a result of combat with oxidative stress. In a case where the positive ion concentration and the negative ion concentration are each not less than 1,000,000 ions/cm³, growth of a plant 10 is remarkably promoted.

A plant cultivation method in accordance with a sixth aspect of the present invention can be arranged such that: in any one of the first through fifth aspects, any one of a fresh weight of the plant, a dry weight of the plant, the number of leaves of the plant, a leaf length of the plant, a root length of the plant, and a nitrate ion content in the plant is increased; or an oxalic acid content in the plant is decreased.

A plant cultivation method in accordance with a seventh aspect of the present invention can be arranged such that, in any one of the first through sixth aspects, the positive and negative ion irradiation step is continuously carried out during a period in which the plant is cultivated.

According to the plant cultivation method, it is confirmed that neither a positive ion nor a negative ion adversely affects growth of a plant. This allows the plant to be continuously irradiated with the positive ion and the negative ion.

A plant cultivation apparatus in accordance with an eighth aspect of the present invention is a plant cultivation apparatus for promoting growth of a plant, including: an ion generating device that generates a positive ion and a negative ion in a space in which the plant is cultivated.

According to the arrangement, a radical is produced from the positive ion and the negative ion each of which is generated by the ion generating device. It is estimated that the positive ion and the negative ion, and an action of the radical (e.g., oxidative stress caused by the radical) promote growth of the plant.

Since it is confirmed that neither a positive ion nor a negative ion adversely affects growth of a plant, it is unnecessary to strictly set a condition under which to generate the positive ion and the negative ion. This makes it possible to promote growth of the plant by a simple arrangement.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 2 Plant cultivation apparatus

10 Plant

11 Sponge

12 Float

13 Hydroponic liquid

14 Hydroponic liquid vessel

20 Control device

21 Illumination device

22 Air sending device

23 Air hole

24 Temperature sensor

25 Timepiece

26 Storage device

27 Control section

30 Case

31 Door

40 Ion generating device

41 Positive ion generating section

42 Negative ion generating section

F Airflow

1. A plant cultivation method for promoting growth of a plant, comprising:
a positive and negative ion irradiation step of irradiating the plant with a positive ion and a negative ion.

2. The plant cultivation method as set forth in claim 1, further comprising:
an air sending step of producing an airflow so that the plant is laterally subjected to the airflow,
the positive and negative ion irradiation step and the air sending step being simultaneously carried out, and
in the positive and negative ion irradiation step, the positive ion and the negative ion each being generated upstream of the airflow.

3. The plant cultivation method as set forth in claim 1, wherein a space surrounding the plant has a positive ion concentration of not less than 1,000,000 ions/cm³ and a negative ion concentration of not less than 1,000,000 ions/cm³.

4. The plant cultivation method as set forth in claims 1, wherein:
any one of a fresh weight of the plant, a dry weight of the plant, the number of leaves of the plant, a leaf length of the plant, a root length of the plant, and a nitrate ion content in the plant is increased; or
an oxalic acid content in the plant is decreased.

5. A plant cultivation apparatus for promoting growth of a plant, comprising:
an ion generating device that generates a positive ion and a negative ion in a space in which the plant is cultivated.
